(19) United States
(12) Patent Application Publication
(10) Pub. No.: US 2010/0165510 A1
(43) Pub. Date: Jul. 1, 2010

(54) VERTICAL MAGNETIC RECORDING MEDIUM AND MAGNETIC RECORDING REPRODUCING APPARATUS

(75) Inventors: Migaku Takahashi, Sendai-shi (JP); Shin Saito, Sendai-shi (JP); Tomoyuki Maeda, Kawasaki-shi (JP); Akihiko Takeo, Kawasaki-shi (JP); Yuzo Sasaki, Ichihara-shi (JP); Ryuji Sakaguchi, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignees: Tohoku University; Toshiba Corporation; Showa Denko K.K.

(21) Appl. No.: 12/601,372

(22) PCT Filed: May 21, 2008
(86) PCT No.: PCT/JP2008/059374

§ 371 Date: Nov. 23, 2009

(30) Foreign Application Priority Data
May 21, 2007 (JP) 2007-133679

(51) Int. Cl. G11B 5/82

(52) U.S. Cl. 360/135; G9B/5.293

(57) ABSTRACT

A magnetic recording medium comprising a substrate, at least one soft magnetic underlayer formed on the substrate, a perpendicular magnetic recording layer formed on the soft magnetic underlayer, and a protective layer formed on the perpendicular magnetic recording layer, is provided wherein the perpendicular magnetic recording layer is comprised of a primary recording layer, a non-magnetic intermediate layer and an auxiliary layer; the primary recording layer comprises magnetic crystal grains and grain boundary portions surrounding the magnetic crystal grains, and has a perpendicular magnetic anisotropy; the auxiliary layer has a negative magneto crystalline anisotropy; and the non-magnetic intermediate layer is formed between the primary recording layer and the auxiliary layer and comprises at least one metal selected from Ru, Rh and Ir, or at least one alloy thereof. This magnetic recording medium exhibits high heat resistance and good recording/reproducing characteristics, and enables a high recording density.

### TECHNICAL FIELD

This invention relates to a perpendicular magnetic recording medium which is suitable for, for example, a hard disk apparatus utilizing a magnetic recording technique, and to a magnetic recording reproducing apparatus.

### BACKGROUND ART

A hard disk drive (HDD) capable of recording and reproducing information, utilized in a computer and other instruments is becoming widely spread year by year because of its large capacity, inexpensiveness, rapid access to data, and high reliability in storage of data. HDD is now popularly used in, for example, home video decks, audio instruments and [symbol] vehicle navigation systems. With the spread of HDD, high-density recording of HDD is eagerly desired, and thus, importance in the research for enhancing the high-density recording of HDD is increasing.

As the magnetic recording system adopted in the commercially available HDD, a perpendicular magnetic recording medium is now being rapidly spread instead of the heretofore used in-plane magnetic recording system. In the perpendicular magnetic recording system, the magnetic crystal grains constituting the magnetic recording layer for recording information have an easy magnetizing axis extending in the direction perpendicular to the substrate surface. The term “easy magnetization axis” as used herein refers to the axis of crystal, in the direction of which the spontaneous magnetization occurs easily. For example, in the case of a cobalt alloy, the easy magnetization axis is an axis (c-axis) parallel to the line normal to the (0001) plane of the hcp structure of cobalt. Therefore when the magnetic recording density is enhanced, the influence of demagnetizing field among the recording bits can be reduced and the magnetostatic stability can be enhanced.

A perpendicular magnetic recording medium generally has a multilayer structure comprised of a substrate, an orientation-controlling underlayer for orientating the magnetic crystal grains within a perpendicular recording layer in the (0001) planer orientation and reducing the orientation dispersion, a perpendicular magnetic recording layer comprising a hard magnetic material, and a protective layer for protecting the surface of the perpendicular magnetic recording layer. The perpendicular magnetic recording medium can additionally have a soft magnetic underlayer between the substrate and the orientation-controlling underlayer, which has a function of concentrating the magnetic flux generated from a magnetic head upon recording.

To enhance the recording density of the perpendicular magnetic recording medium, it is required that the noise is reduced while a good heat stability is maintained. As the method for reducing the noise, there is generally adopted a method for magnetically isolating magnetic crystal grains of the recording layer within the film plane and reducing the magnetic interaction among the magnetic crystal grains, and using finely divided magnetic crystal grains having a greatly reduced grain size.

More specifically, a method of forming a perpendicular magnetic recording layer having a granular structure has been proposed wherein SiO₂ or other additives are incorporated in the magnetic recording layer and thus, in the granular structure, magnetic crystal grains are surrounded by grain boundaries predominantly comprised of SiO₂ or other additives. However, this method has a problem such that magneto crystalline isotropy energy (Kᵤ) of the magnetic crystal grains must be inevitably increased for maintaining good heat stability with the purpose of reducing the noise. The increase in magneto crystalline isotropy energy (Kᵤ) of the magnetic crystal grains is accompanied by increase in the anisotropic magnetic field, the saturation magnetization and the coercive force. This leads to increase in the recordation magnetization required for magnetization switching upon writing, and thus, writability by a recording head is reduced. Consequently the recording/reproducing characteristics are deteriorated.

To solve the above-mentioned problem, composite media have been proposed which have a granular structure wherein a layer (auxiliary layer) comprised of magnetically isolated soft magnetic crystal grains is formed on the upper side or underside of the perpendicular magnetic recording layer (primary recording layer) comprised of magnetically isolated hard magnetic crystal grains (for example, IEEE Transaction on Magnetics, vol. 41, pp 537). In the composite media, hard magnetic grains and soft magnetic grains are ferromagnetically exchange-coupled with each other, and therefore, in the state of residual magnetization under which external magnetic field is not applied, the magnetic orientation of the total of soft magnetic grains and hard magnetic grains in the whole magnetic recording layer comprised of the primary recording layer and the auxiliary layer is aligned perpendicularly in the same fashion as in the conventional perpendicular magnetic recording media.

However, in contrast to the conventional perpendicular magnetic recording medium, when a recording magnetic field is applied to the above-mentioned composite media, the magnetization rotation in the auxiliary layer commences earlier than that in the primary recording layer.

Therefore, when the magnetization reversal occurs, hard magnetic grains in the primary recording layer in the composite media are influenced by the applied magnetic field and their demagnetizing field, and further assisted by the exchange magnetic field interacted between the hard magnetic grains and the soft magnetic grains, and hence, the magnetization reversal easily occurs at a low magnetic field as compared with the conventional perpendicular magnetic recording medium. Thus, the writability is remarkably enhanced. However, the exchange-coupled primary recording layer and auxiliary layer are together subject to heat fluctuation, and thus, when a soft magnetic layer comprised of crystal grains exhibiting a small absolute value for magnetocrystalline isotropy energy (Kᵤ) is used as the auxiliary layer, the average Kᵤ value of the crystal grains in the whole recording layer is lowered and the thus resistance to heat fluctuation is reduced.

In contrast, improved composite media have been proposed wherein the magnetic recording layer has, in addition to a primary recording layer, an auxiliary recording layer comprising magnetic crystal grains having a Kᵤ value which is a large absolute value but negative to enhance the resistance to heat fluctuation of the whole magnetic recording layer (JP 2006-351058 A1). As described in this patent document, it is expected that the resistance to heat fluctuation and the writability are improved by the provision of such auxiliary recording layer.

However, in the composite media of the above-mentioned patent document, the primary recording layer and the auxiliary recording layer are strongly exchange-coupled with each other, a squareness ratio (Rs) of the hysteresis loop is liable to be smaller than 1 due to the influence of the negative Kᵤ value of the auxiliary recording layer. Consequently, the resistance to heat fluctuation is not enhanced to a satisfying extent.

Further, a magnetic recording medium having a non-magnetic intermediate layer provided between a primary recording and an auxiliary recording layer has been proposed (IEEE Transaction on Magnetics, vol. 41, pp 3138, and Digests of the 30th Annual Conference of Magnetics Society of Japan, 13aC-7). This magnetic recording medium will be described below.

### DISCLOSURE OF THE INVENTION

### Problems to be Solved by the Invention

In view of the foregoing, a primary object of the present invention is to provide a perpendicular magnetic recording medium exhibiting high heat stability and good recording and reproducing characteristics, and enabling a high recording density; and further to provide a magnetic recording apparatus provided with this magnetic recording medium.

### Means for Solving the Problems

Thus, in accordance with the present invention, there are provided the following magnetic recording mediums and magnetic recording and reproducing apparatus.

(1) A magnetic recording medium comprising a substrate, at least one soft magnetic underlayer formed on the substrate, a perpendicular magnetic recording layer formed on the soft magnetic underlayer, and a protective layer formed on the perpendicular magnetic recording layer;

characterized in that:

said perpendicular magnetic recording layer is comprised of a primary recording layer, a non-magnetic intermediate layer and an auxiliary layer;

the primary recording layer comprises magnetic crystal grains and grain boundary portions surrounding the magnetic crystal grains, and has a perpendicular magnetic anisotropy;

the auxiliary layer has a negative magneto crystalline anisotropy; and

the non-magnetic intermediate layer is formed between the primary recording layer and the auxiliary layer and comprises at least one metal selected from the group consisting of ruthenium, rhodium and iridium, or at least one alloy thereof.

(2) The magnetic recording medium as mentioned above in (1), wherein the absolute value of the negative magneto crystalline anisotropy of the auxiliary layer is at least 10⁵ erg/cc.

(3) The magnetic recording medium as mentioned above in (1) or (2), wherein the auxiliary layer has a thickness of at least 0.5 nm.

(4) The magnetic recording medium as mentioned above in any one of (1) to (3), wherein the thickness of the auxiliary layer is not larger than a half of the thickness of the primary recording layer.

(5) The magnetic recording medium as mentioned above in any one of (1) to (4), wherein the auxiliary layer comprises at least one alloy selected from the group consisting of Co—Ir, Co—Fe, Mn—Sb, Fe—C and Fe—Pt.

(6) The magnetic recording medium as mentioned above in (5), wherein the auxiliary layer is comprised of a Co—Ir alloy and the content of iridium in the alloy is in the range of 5 to 40% by atom based on the alloy.

(7) The magnetic recording medium as mentioned above in any one of (1) to (6), wherein the auxiliary layer comprises magnetic crystal grains and grain boundary portions surrounding the magnetic crystal grains, wherein the magnetic crystal grains comprise the alloy as described above in (5) or (6).

(8) The magnetic recording medium as mentioned above in (7), wherein the grain boundary portions in the auxiliary layer are comprised of an oxide, nitride or carbide of at least one element selected from the group consisting of Si, Ti, Cr, Al, Mg, Ta and Y.

(9) The magnetic recording medium as mentioned above in (8), wherein the total content of the oxide, nitride or carbide in the auxiliary layer is in the range of 1% to 20% by mole, based on the sum of the magnetic crystal grains and the grain boundary portions.

(10) The magnetic recording medium as mentioned above in anyone of (1) to (9), wherein the non-magnetic intermediate layer has a thickness in the range of 0.3 nm to 2 nm.

(11) The magnetic recording medium as mentioned above in any one of (1) to (10), wherein the non-magnetic intermediate layer comprises crystal grains and grain boundary portions surrounding the crystal grains, wherein the crystal grains are comprised of at least one metal selected from the group consisting of ruthenium, rhodium and iridium, or at least one alloy thereof.

(12) The magnetic recording medium as mentioned above in (11), wherein the grain boundary portions in the non-magnetic intermediate layer are comprised of an oxide, nitride or carbide of at least one element selected from the group consisting of Si, Ti, Cr, Al, Mg, Ta and Y.

(13) The magnetic recording medium as mentioned above in (12), wherein the total content of the oxide, nitride or carbide in the non-magnetic intermediate layer is in the range of 1% to 20% by mole, based on the sum of the crystal grains and the grain boundary portions.

(14) The magnetic recording medium as mentioned above in any one of (1) to (13), wherein the magnetic crystal grains in the primary magnetic layer comprise cobalt and platinum, and have a hexagonal close-packed (hcp) structure and are (0001) plane-orientated.

(15) The magnetic recording medium as mentioned above in any one of (1) to (14), wherein the grain boundary portions in the primary recording layer are comprised of an oxide, nitride or carbide of at least one element selected from the group consisting of Si, Ti, Cr, Al, Mg, Ta and Y.

(16) The magnetic recording medium as mentioned above in (16), wherein the total content of the oxide, nitride or carbide in the primary recording layer is in the range of 5% to 20% by mole, based on the sum of the magnetic crystal grains and the grain boundary portions.

(17) The magnetic recording medium as mentioned above in any one of (1) to (16), wherein the soft magnetic underlayer comprises metal or an alloy, which is at least one selected from the group consisting of Co—Zr—Nb, Co—B, Co—Ta—Zr, Fe—Si—Al, Fe—Ta—C, Co—Ta—C, Ni—Fe, Fe, Fe—Co—B, Fe—Co—N, Fe—Ta—N and Co—Ir.

(18) The magnetic recording medium as mentioned above in any one of (1) to (17), wherein the soft magnetic underlayer is comprised of a Co—Ir alloy and the content of iridium in the alloy is in the range of 5% to 40% by atom based on the alloy.

(19) The magnetic recording medium as mentioned above in any one of (1) to (18), which further comprises a non-magnetic underlayer, comprised of metal or an alloy, and formed between the soft magnetic underlayer and the perpendicular magnetic recording layer; wherein said metal or said alloy in the non-magnetic underlayer has a (0001) plane-orientated hexagonal close-packed (hcp) structure; or a (111) plane-orientated structure comprising a misfit-layered lattice having a face-centered cubic (fcc) structure combined with a body-centered cubic (bcc) structure, or a (111) plane-orientated structure comprising a misfit-layered lattice having a face-centered cubic (fcc) structure combined with a hexagonal close-packed (hcp) structure.

(20) The magnetic recording medium as mentioned above in (19), wherein the non-magnetic underlayer is comprised of metal or an alloy, which is at least one selected from those which are (0001) plane-orientated and selected from the group consisting of Ru, Ti, Re, Ru—Cr, Ru—W and Ru—Co, and those which are (111) plane-orientated and selected from the group consisting of Pt—Cr, Au—Cr, Pd—Cr, Ir—Cr, Pd—W, Pd—W—Cr and Ir—Ti.

(21) The magnetic recording medium as mentioned above in (19) or (20), which further comprises a seed layer formed between the soft magnetic underlayer and the non-magnetic underlayer.

(22) The magnetic recording medium as mentioned above in (21), wherein the seed layer is comprised of metal or an alloy, which is at least one selected from the group consisting of Pd, Pt, Ta, Ni—Ta, Ni—Nb, Ni—Zr, Ni—Fe—Cr and Ni—Fe.

(23) A magnetic recording reproducing apparatus provided with the magnetic recording medium as mentioned above in any one of (1) to (22), and a magnetic head for recording and reproducing an information.

### EFFECT OF THE INVENTION

The perpendicular magnetic recording medium according to the present invention exhibits an improved signal/sound-to-noise ratio, good overwrite (OW) characteristics and enhanced resistance to heat fluctuation, and enables a high recording density.

### BRIEF DESCRIPTION OF THE DRAWINGS

FIG. 1 is a schematic cross-section of an example of the perpendicular magnetic recording medium according to the present invention.

FIG. 2 is a schematic cross-section of another example of the perpendicular magnetic recording medium according to the present invention.

FIG. 3 shows (111) orientation in the fcc structure of crystal grains.

FIG. 4 is a schematic cross-section of a further example of the perpendicular magnetic recording medium according to the present invention.

FIG. 5 is a perspective illustration of an example of the magnetic recording reproducing apparatus according to the present invention.

FIG. 6 is an example of hysteresis loop in the direction vertical to the plane of the magnetic recording layer, wherein the ordinate denotes Kerr rotation angle θ and the abscissa denotes applied magnetic field H.

FIG. 7 shows the relationship between an amount of iridium added in the auxiliary layer and a crystalline isotropy energy (Kᵤ) of the auxiliary layer.

FIG. 8 shows the relationship between an amount of iridium added in the auxiliary layer and a signal-to-noise ratio (SNRm) of the magnetic recording medium.

FIG. 9 shows the relationship between an amount of iridium added in the auxiliary layer and an overwrite (OW) characteristic of the magnetic recording medium.

FIG. 10 shows the relationship between an amount of iridium added in the auxiliary layer and a V₁₀₀/V₀ ratio of the magnetic recording medium.

FIG. 11 is a graph showing the relationship between an amount (y) of SiO₂ added in the auxiliary layer (provided that an amount (z) of SiO₂ added in the primary recording layer is 8) and an SNRm of the magnetic recording medium.

FIG. 12 is a graph showing the relationship between an amount (z) of SiO₂ added in the primary recording layer (provided that an amount (y) of SiO₂ added in the auxiliary layer is 8) and an SNRm of the magnetic recording medium.

FIG. 13 is a graph showing the relationship between an amount (a) of SiO₂ added in the non-magnetic intermediate layer and an SNRm of the magnetic recording medium.

FIG. 14 is a graph showing the relationship between a thickness of the non-magnetic intermediate layer and an Hc of the magnetic recording medium.

FIG. 15 is a graph showing the relationship between a thickness of the non-magnetic intermediate layer and an Hs of the magnetic recording medium.

FIG. 16 is a graph showing the relationship between a thickness of the non-magnetic intermediate layer and an Rs of the magnetic recording medium.

FIG. 17 is a graph showing the relationship between a thickness of the non-magnetic intermediate layer and an SNRm of the magnetic recording medium.

FIG. 18 is a graph showing the relationship between a thickness of the non-magnetic intermediate layer and a V₁₀₀/V₀ ratio of the magnetic recording medium.

### EXPLANATION OF REFERENCE NUMERALS

1 Substrate
2 Soft magnetic underlayer
3 Perpendicular magnetic recording layer
3-1 Auxiliary layer
3-2 Non-magnetic intermediate layer
3-3 Primary recording layer
4 Protective layer
5 Non-magnetic underlayer
6 Seed layer
10, 20, 40 Perpendicular magnetic recording medium
51 Magnetic disk
52 Spindle
53 Slider
54 Suspension
55 Arm
56 Voice coil motor
57 Fixed axis
58 Housing

### BEST MODE FOR CARRYING OUT THE INVENTION

The invention will now be described in detail.

The magnetic recording medium of the present invention comprises a substrate, at least one soft magnetic underlayer formed on the substrate, a perpendicular magnetic recording layer formed on the soft magnetic underlayer, and a protective layer formed on the perpendicular magnetic recording layer.

The perpendicular magnetic recording layer is comprised of a primary recording layer, a non-magnetic intermediate layer and an auxiliary layer; and the primary recording layer comprises magnetic crystal grains and grain boundary portions surrounding the magnetic crystal grains, and has a perpendicular magnetic anisotropy.

The auxiliary layer has a negative magneto crystalline anisotropy.

The non-magnetic intermediate layer is formed between the primary recording layer and the auxiliary layer and comprises at least one metal selected from the group consisting of ruthenium, rhodium and iridium, or at least one alloy thereof.

The magnetic recording reproducing apparatus of the present invention is provided with the above-mentioned perpendicular magnetic recording medium and a magnetic head for recording and reproducing an information.

The perpendicular magnetic recording medium according to the present invention will be described specifically with reference to the attached drawings.

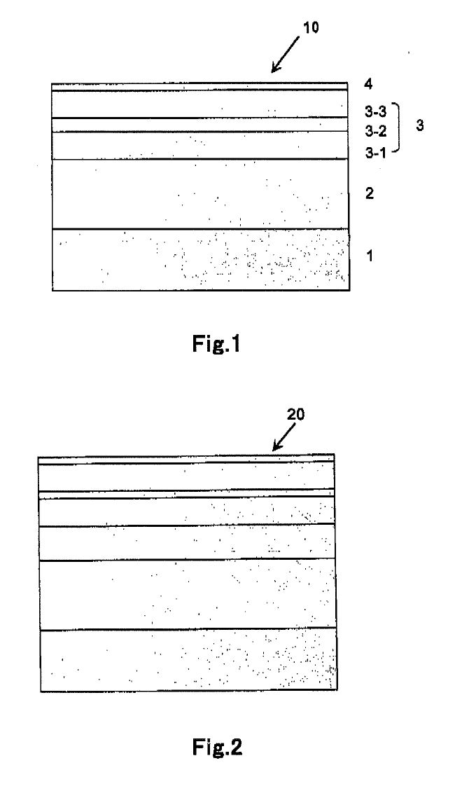

FIG. 1 is a schematic cross-section of an example of the perpendicular magnetic recording medium according to the present invention.

As illustrated in FIG. 1, the magnetic recording medium 10 has a multilayer structure which comprises a substrate 1, a soft magnetic underlayer 2 formed on the substrate 1, a perpendicular magnetic recording layer 3 formed on the soft magnetic underlayer 2, and a protective layer 4 formed on the perpendicular magnetic recording layer 3. The perpendicular magnetic recording layer 3 is comprised of three layers, i.e., an auxiliary layer 3-1, a non-magnetic intermediate layer 3-2 and a primary recording layer 3-3.

The perpendicular magnetic recording layer in the magnetic recording medium of the present invention can have at least one auxiliary layer, at least one non-magnetic intermediate layer and at least one primary recording layer.

The primary recording layer in the perpendicular magnetic recording medium has preferably a granular structure comprising magnetic crystal grains and non-magnetic grain boundary portions surrounding the magnetic crystal grains. By the formation of non-magnetic grain boundary portions surrounding the magnetic crystal grains in the primary recording layer, the mutual exchange-coupled function between the magnetic crystal grains can be reduced and therefore the transition noise at recordation and reproduction can be minimized.

The magnetic crystal grains in the primary magnetic layer are preferably comprised of an alloy having a hexagonal close-packed (hcp) structure comprising cobalt and platinum, and are (0001) plane-orientated. When crystal grains of a cobalt-containing alloy having a hcp structure are (0001) orientated, the easy magnetization axis is orientated in a direction vertical to the substrate surface whereby the perpendicular magnetic anisotropy is preferably manifested. More preferably the magnetic crystal grains are comprised of, for example, an alloy selected from a Co—Pt alloy and Co—Pt—Cr alloy. These alloys have high magneto crystalline anisotropic energy and therefore, preferably exhibit a high resistance to heat fluctuation. To improve magnetic properties, these alloys may have added therein some elements such as Ta, Cu, B or Nd, if desired.

It can be confirmed by observation of the surface of the primary recording layer by a transmission electron microscope (TEM) whether the primary recording layer has a granular structure or not. By using an energy dispersive X-ray spectroscopy (EDX) in combination with the TEM, the elements in the magnetic crystal grains and the grain boundary portions can be identified and the compositions (contents) of the elements can be determined.

The orientation plane in each layer in the magnetic recording medium can be evaluated by, for example, a θ-2θ method using the conventional X-ray diffraction (XRD) method.

The grain boundary portions in the primary recording layer are preferably comprised of an oxide, nitride or carbide of at least one element selected from the group consisting of Si, Ti, Cr, Al, Mg, Ta and Y. These compounds are advantageous because they are not easily formed into a solid-solution with the above-mentioned material for forming the crystal grains, and thus they tend to be deposited.

As specific examples of the compounds for the grain boundary portions in the primary recording layer, there can be mentioned SiOₓ, TiOₓ, CrOₓ, AlOₓ, MgOₓ, TaOₓ, YOₓ, TiNₓ, CrNₓ, SiNₓ, AlNₓ, TaNₓ, SiCₓ, TiCₓ, and TaCₓ.

The material for forming the grain boundary portions may be either crystalline or non-crystalline.

The total content of the above-mentioned oxide, nitride or carbide material in the primary recording layer is in the range of 5% to 20% by mole based on the sum of the magnetic crystal grains and the grain boundary regions in the primary recording layer. If the total content is smaller than 5% by mole, the granular structure is difficult to maintain. In contrast, if the total content is larger than 20% by mole, the reproduction output in the R/W characteristic is undesirably reduced.

The primary recording layer comprised of the above-mentioned materials may have a multilayer structure composed of two or more layers. In the multilayer structure, at least one layer thereof has the above-mentioned granular structure.

A material constituting the auxiliary layer in the magnetic recording medium according to the present invention has a negative magneto crystalline anisotropy energy (Ku) in the direction perpendicular to the medium plane. That is, the difficult magnetization axis of the auxiliary layer is perpendicular to the medium plane. The easy magnetization axis of the auxiliary layer is within a plane perpendicular to the difficult magnetization axis, i.e., within a plane parallel to the medium plane. The easy magnetization axis can be in any direction within the plane perpendicular to the difficult magnetization axis. Thus, in this magnetic body having magnetic characteristics, the easy magnetization axis can extend in an arbitral direction in a plane. The plane in which the easy magnetization axis is present is hereinafter referred to in this specification “easy magnetization plane” when appropriate.

The material having a negative magneto crystalline anisotropy energy (Ku) includes, for example, Co—Ir, Co—Fe, Mn—Sb, Fe—C and Fe—Pt. The mark “Co—Ir” refers to an alloy comprised of cobalt and iridium, but should not be limited to an alloy containing cobalt and iridium at an atomic ratio of 1:1. This type of mark is used for alloys in this specification including the claims. As the Fe—Pt alloy, Fe₃—Pt is preferable.

The absolute value of the negative magneto crystalline anisotropy (Ku) of the auxiliary layer is preferably at least 10⁵ erg/cc, the reason for which will be described below.

As hereinbefore mentioned, exchange-coupled primary recording layer and auxiliary layer are together subject to heat fluctuation as a combination thereof, and thus, if the auxiliary layer has a small absolute value for magneto crystalline isotropy energy (Kᵤ), Kᵤ of a whole perpendicular magnetic recording layer is lowered and the heat fluctuation resistance of the whole recording layer is reduced. Therefore, for example, in the composite media described in IEEE Transaction on Magnetics, vol. 41, pp 537, cited above, an auxiliary layer comprised of a soft magnetic material is used which is regarded to have a Ku value of zero, and thus, the thickness of a primary recording layer must be large, and thus, the total thickness of a whole magnetic recording layer comprising the primary recording layer and the auxiliary layer must be large, to give a magnetic recording layer having a satisfying resistance to heat fluctuation. This requirement is rather difficult to attain for a perpendicular magnetic recording medium with a small distance between the soft magnetic underlayer (SUL) and the recording head. The primary recording layer and the auxiliary layer have easy magnetization axes which are perpendicular to each other, but, the resistance to heat fluctuation is regarded to be the same as that in the case when the primary recording layer and the auxiliary layer have easy magnetization axes parallel to each other. Thus, when the auxiliary layer has a large Ku, the microstructure of the perpendicular magnetic recording layer has a Ku which is intermediate between the absolute values of the Ku's of the primary recording layer and the auxiliary layer, and the microstructure exhibits a heat fluctuation resistance of a magnitude corresponding to the intermediate Ku.

Therefore the auxiliary layer in the magnetic recording layer of the present invention also preferably has a large absolute Ku value. More specifically, we confirmed by experimentation that the auxiliary layer preferably has a Ku value of at least 10⁵ erg/cc, and more preferably at least 10⁶ erg/cc.

The above-mentioned material such as Co—Ir, Co—Fe, Mn—Sb, Fe—C and Fe₃—Pt can be mentioned as typical examples of the material having the above-mentioned large Ku value. Especially a Co—Ir alloy has a hcp structure and a lattice constant, which are similar to those of a Co—Cr—Pt alloy, popularly used in a magnetic recording layer in the conventional HDD media. Therefore, even when a primary recording layer comprised of a Co—Cr—Pt alloy is superposed upon an auxiliary layer comprised of Co—Ir, the crystalline orientation of the whole magnetic recording layer is stable. Therefore, the Co—Cr—Pt alloy is superposed on the auxiliary layer of (0001) plane-orientated Co—Cr—Pt alloy, the Co—Cr—Pt alloy is easily (0001) plane-orientated. In this constitution, the easy magnetization plane of the Co—Ir alloy in the auxiliary layer coincides with the layer plane, and the easy magnetization axis of the Co—Cr—Pt alloy in the primary recording layer is perpendicular to the layer plane.

If a (0001) plane-orientated Co—Cr—Pt alloy layer is formed on a non-magnetic underlayer in the conventional perpendicular magnetic recording medium for HDD, then, it is possible to form a Co—Cr—Pt alloy magnetic layer on the non-magnetic underlayer and further to form a Co—Ir alloy auxiliary layer on the Co—Cr—Pt alloy magnetic layer, whereby the Co—Ir alloy layer can be (0001) plane-orientated. In this constitution, the easy magnetization plane of the Co—Ir alloy in the auxiliary layer also coincides with the layer plane, and the easy magnetization axis of the Co—Cr—Pt alloy in the primary recording layer is also perpendicular to the layer plane.

In the case when a Co—Ir alloy is used in the auxiliary layer, magnetic properties of the auxiliary layer such as saturation magnetization (Ms) and the absolute value of Ku can be adjusted by varying the content of Ir in the Co—Ir alloy. For example, when the content of Ir in the Co—Ir alloy is in the range of 5 to 40% by atom, the Ku can be negative and an absolute value thereof can be at least 10⁵ erg/cc. Especially when the content of Ir in the Co—Ir alloy is in the range of 10 to 30% by atom, the Ku can be negative and an absolute value thereof can be preferably at least 10⁶ erg/cc.

The auxiliary layer preferably has a thickness of at least 0.5 nm, more preferably at least 1 nm. If the thickness of the auxiliary layer is smaller than 0.5 nm, the beneficial effect obtained by tilted media is reduced, and the uniformity over the whole media becomes difficult to maintain.

The thickness of the auxiliary layer is preferably not larger than a half of the thickness of the primary recording layer. When the thickness of the auxiliary layer is larger than a half of the thickness of the primary recording layer, the residual magnetization is predominantly orientated in an in-plane direction, and the intensity of signal as a perpendicular magnetic recording medium is lowered.

The auxiliary layer comprised of the above-mentioned materials may have a multilayer structure composed of two or more layers.

The auxiliary layer may preferably have a granular structure comprising magnetic crystal grains and non-magnetic grain boundary portions surrounding the magnetic crystal grains, which is similar to that of the primary magnetic layer. Due to such a granular structure, the mutual exchange-coupled function between the magnetic crystal grains can be reduced and therefore the transition noise at recordation and reproduction can be minimized.

The material for forming the grain boundary portions in the auxiliary layer is preferably comprised of an oxide, nitride or carbide of at least one element selected from the group consisting of Si, Ti, Cr, Al, Mg, Ta and Y. These compounds are advantageous because they are not easily formed into a solid-solution with the above-mentioned material for forming the crystal grains, and thus they tend to be deposited.

As specific examples of the compounds for the grain boundary portions, there can be mentioned SiOₓ, TiOₓ, CrOₓ, AlOₓ, MgOₓ, TaOₓ, YOₓ, TiNₓ, CrNₓ, SiNₓ, AlNₓ, TaNₓ, SiCₓ, TiCₓ, and TaCₓ.

The material for forming the grain boundary portions in the auxiliary layer may be either crystalline or non-crystalline.

The total content of the above-mentioned oxide, nitride or carbide material in the auxiliary recording layer is in the range of 1% to 20% by mole based on the sum of the magnetic crystal grains and the grain boundary regions in the auxiliary layer. If the total content is smaller than 1% by mole, the effect of enhancement of SNR is poor. In contrast, if the total content is larger than 20% by mole, the effect of improvement in the O/W characteristic is poor.

In the perpendicular magnetic recording medium according to the present invention, the perpendicular magnetic recording layer is comprised of a primary recording layer, a non-magnetic intermediate layer and an auxiliary layer, wherein the non-magnetic intermediate layer is formed between the primary recording layer and the auxiliary layer and comprises at least one metal selected from ruthenium, rhodium and iridium, or at least one alloy thereof.

As mentioned above, in the case when a magnetic material having a negative Ku is used in an auxiliary layer in the conventional perpendicular magnetic recording medium, Rs is deteriorated, and therefore, even when the Ku is a large absolute value, the resistance to heat fluctuation is not enhanced to the desired extent. In contrast, it has been found by the present inventors that a squareness ratio can be maintained at 1 and the resistance to heat fluctuation can be improved by the provision of a non-magnetic intermediate layer between the primary recording layer and the auxiliary layer comprised of a material having a negative Ku, which intermediate layer is comprised of at least one metal selected from ruthenium, rhodium and iridium, or at least one alloy thereof.

It is suggested in JP 2006-351058 A1, cited above, that an intermediate layer having a thickness of not larger than 2 nm, comprised of a non-magnetic material, may be formed between the primary recording layer and the auxiliary recording layer having a negative Kᵤ value. However, this patent document is silent on the specific material for the non-magnetic material.

In composite media of the type having a soft-magnetic auxiliary layer together with a primary recording layer, it is studied to provide an intermediate non-magnetic recording layer between the primary recording layer and the auxiliary layer, for further reducing Hc or improving other properties. For example, it has been proposed in composite media having a primary recording layer and an auxiliary layer comprised of Fe—SiO₂ as a soft-magnetic material to insert an intermediate layer comprised of Pd—SiO₂ between the primary recording layer and the auxiliary layer (IEEE Transaction on Magnetics, vol. 41, pp 3138). Further, it has been proposed in composite media having a primary recording layer and an auxiliary layer comprised of Co—SiO₂ as a soft-magnetic material to insert an intermediate layer comprised of Pt—SiO₂ between the primary recording layer and the auxiliary layer (Digests of the 30th Annual Conference of Magnetics Society of Japan, 13aC-7). However, it is to be noted that, in composite medial having a primary recording layer and an auxiliary layer comprised of a magnetic material having a negative Ku value, as in the perpendicular magnetic recording medium of the present invention, when a non-magnetic intermediate layer is inserted between the primary recording layer and the magnetic auxiliary layer, the effect of reducing Hc is obtained but Rs is undesirably deteriorated. This will be seen from comparative examples, explained below.

The present inventors have found that the above-mentioned composite media described in IEEE Transaction on Magnetics, vol. 41, pp 3138, and Digests of the 30th Annual Conference of Magnetics Society of Japan, 13aC-7, cannot enhance Rs, but, the composite media having a primary magnetic recording layer and a magnetic auxiliary layer having a negative Ku value, as the magnetic recording medium of the present invention, exhibits a remarkable effect of enhancing Rs, only when an intermediate layer comprising at least one metal selected from ruthenium, rhodium and iridium, or at least one alloy thereof, is inserted. The reason for the above fact cannot be clearly elucidated. That is, the inventors cannot rely on the reason, suggested in the above two literatures, such that the desired effect would be obtained by the fact that the mutual exchange-coupled force between the primary magnetic recording layer and the auxiliary layer is adequately reduced. As seen from Example 5, shown below, the non-magnetic intermediate layer used in the present invention influences the magnitudes of Hc and Hs relative to the layer thickness. These specific behaviors are presumed to influence the beneficial effects of Rs enhancement.

As taught in the above-mentioned literatures, in the case when a thin intermediate layer comprised of platinum or palladium is inserted between the primary recording layer and the auxiliary layer, a ferromagnetic exchange-coupling force is generally applied between the primary recording layer and the auxiliary layer. In contrast, in the case when an intermediate layer comprised of ruthenium, rhodium or iridium is inserted between the primary recording layer and the auxiliary layer, as in the magnetic recording medium of the present invention, an anti-ferromagnetic exchange-coupling force tend to be applied, and it would be possible that the anti-ferromagnetic exchange-coupling force produces the beneficial effect, although the reason for which is not clear at present.

The non-magnetic intermediate layer preferably has a thickness in the range of 0.3 nm to 2 nm, more preferably 0.5 nm to 1.8 nm. When the thickness of the intermediate layer is smaller than 0.3 nm, it is difficult to make a continuous film and the effect of enhancing the squareness ratio is manifested not to a great extent. In contrast, when the thickness of the intermediate layer is larger than 2 nm, the exchange coupling force is weakened and the effect of enhancing the writability is manifested not to a great extent.

The thickness of the non-magnetic intermediate layer can be determined by the observation of cross-section using a transmission electron microscope.

In the case when a non-magnetic intermediate layer having a granular structure is used, magnetic isolation of magnetic crystal grains in the primary recording layer or auxiliary layer, which are formed on the intermediate layer, is promoted and hence the SNR characteristic is desirably enhanced.

The grain boundary portions in the non-magnetic intermediate layer are preferably comprised of an oxide, nitride or carbide. These compounds are advantageous because they are not easily formed into a solid-solution with the above-mentioned material for forming the non-magnetic crystal grains, and thus they tend to be deposited.

As specific examples of the compounds for the grain boundary portions, there can be mentioned SiOₓ, TiOₓ, CrOₓ, AlOₓ, MgOₓ, TaOₓ, YOₓ, TiNₓ, CrNₓ, SiNₓ, AlNₓ, TaNₓ, SiCₓ, TiCₓ, and TaCₓ.

The material for the grain boundary portions in the non-magnetic intermediate layer may be either crystalline or non-crystalline.

The total amount of the material for the grain boundary portions in the non-magnetic intermediate layer is preferably in the range of 1% to 20% by mole, based on the sum of the non-magnetic crystal grains and the grain boundary regions in the non-magnetic intermediate layer. When the amount of the material for the grain boundary portions is smaller than 1% by mole, the effect of SNR enhancement is manifested not to a great extent. In contrast, when the amount of the material for the grain boundary portions is larger than 20% by mole, the orientation of the adjacent auxiliary layer or primary recording layer is reduced.

A soft magnetic underlayer is formed between the substrate and the perpendicular magnetic recording layer. By the formation of the soft magnetic underlayer exhibiting a high magnetic permeability, a perpendicular double layer medium is provided. In this perpendicular double layer medium, the soft magnetic underlayer has a part of the functions of a magnetic head, for example, a single-pole magnetic head, for magnetizing the perpendicular magnetic recording layer. For Example, it has a function of allowing the magnetic field from a magnetic head to pass in the horizontal direction and come closer to the magnetic head side. Thus, a sufficient perpendicular magnetic field can be sharply applied to the recording layer, and the effect of recordation and reproduction is improved.

As specific examples of the material for the soft magnetic underlayer, there can be mentioned metal or an alloy, which is selected from Co—Zr—Nb, Co—B, Co—Ta—Zr, Fe—Si—Al, Fe—Ta—C, Co—Ta—C, Ni—Fe, Fe, Fe—Co—B, Fe—Co—N, Fe—Ta—N and Co—Ir.

It is possible that both of the soft magnetic underlayer and the auxiliary layer are comprised of a Co—Ir alloy. In this case, the materials in these layers can be distinguished by adopting different alloy compositions depending upon the intended functions, and, for example, by incorporating SiO₂ for forming grain boundary portions in the auxiliary layer comprised of Co—Ir alloy grains.

The soft magnetic underlayer may have a multilayer structure composed of two or more layers. In the multilayer structure, the layers may be different in the kind of materials, the amounts thereof and the thickness. As a modification of the soft magnetic underlayer, a triple layer structure comprising a ruthenium layer sandwiched between two soft magnetic underlayers may be used.

An additional layer, for example, a magnetic bias-imparting layer such as an in-plane hard magnetic layer or an antiferromagnetic layer may be formed between the substrate and the soft magnetic underlayer. In general, a soft magnetic underlayer tend to form domains from which a spike noise is easily produced. By applying magnetic field in one radius direction in the magnetic bias-imparting layer, a bias-magnetic field is applied to the soft magnetic underlayer formed on the bias-imparting layer whereby the undesirable production of magnetic wall can be avoided. A bias-imparting layer with a laminate structure can also be adopted whereby the magnetic anisotropy is finely dispersed to suppress the formation of a large domain.

As specific examples of the material for the bias-imparting layer, there can be mentioned Co—Cr—Pt, Co—Cr—Pt—B, Co—Cr—Pt—Ta, Co—Cr—Pt—Ta—Nd, Co—Sm, Co—Pt, Fe—Pt, Co—Pt—O, Co—Pt—Cr—O, Co—Pt—SiO₂, Co—Cr—Pt—SiO₂, Co—Cr—PtO—SiO₂, Fe—Mn, Ir—Mn and Pt—Mn.

FIG. 2 is a schematic cross-section of another example of the perpendicular magnetic recording medium according to the present invention.

As illustrated in FIG. 2, the magnetic recording medium 20 has a multilayer structure which comprises a substrate 1, a soft magnetic underlayer 2 formed on the substrate 1, a non-magnetic underlayer 5 formed on the soft magnetic underlayer 2, a perpendicular magnetic recording layer 3 formed on the non-magnetic underlayer 5, and a protective layer 4 formed on the perpendicular magnetic recording layer 3. The perpendicular magnetic recording layer 3 is comprised of three layers, i.e., an auxiliary layer 3-1, a non-magnetic intermediate layer 3-2 and a primary recording layer 3-3.

By forming a non-magnetic underlayer 5 between the soft magnetic underlayer 2 and the perpendicular magnetic recording layer 3, crystalline orientation in the perpendicular magnetic recording layer can be improved, and magnetic isolation of magnetic crystal grains in the plane can be promoted.

The material for the non-magnetic underlayer preferably includes metal or an alloy, which has a (0001) plane-orientated hexagonal close-packed (hcp) structure, and, as specific examples thereof, there can be mentioned single metals such as Ru, Ti and Re; and alloys such as Ru—Cr, Ru—W and Ru—Co.

Further, the non-magnetic underlayer preferably includes metal or an alloy which has a (111) plane-orientated structure comprising a misfit-layered lattice having a face-centered cubic (fcc) structure combined with a body-centered cubic (bcc) structure, or a (111) plane-orientated structure comprising a misfit-layered lattice having a face-centered cubic (fcc) structure combined with a hexagonal close-packed (hcp) structure.

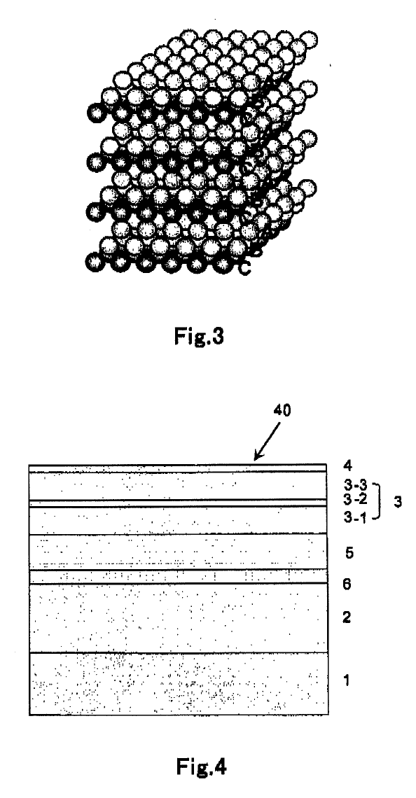

The (111) plane-orientated face-centered cubic (fcc) structure is illustrated in FIG. 3 wherein three planes (A, B and C) each having close-packed atoms are periodically superposed to form a multilayer (A→B→C→A→B→C→A→B→C→ . . . ). In the misfit-layered lattice, elements of a body-centered cubic (bcc) structure or a hexagonal close-packed (hcp) structure are incorporated in the (111) plane-orientated fcc structure whereby the periodical arrangement (A→B→C→A→B→C→A→B→C→ . . . ) is disordered and the lattice is misfit-layered (e.g., (A→B→C→A→C→A→B→C→ . . . ). The misfit-layered lattice can be observed by, for example, a transmission electron microscope (TEM). By an in-plane X-ray diffraction analysis, a diffraction peak attributed to the (111) plane-orientation appears and another diffraction peak appears at a smaller angle side of the (111) plane-orientation peak. The latter diffraction peak appears at an angle different from that attributable to the reflection condition for the fcc structure. Thus, TEM analysis reveals that laminate defects occur without periodicity, and X-ray diffraction analysis reveals that laminate defects occur. Therefore these defects are called misfit-layered lattice.

The (0001) plane-orientated hcp structure is also a close packed structure which is similar to the fcc structure. In the hcp structure, two planes (A and B) each having close-packed atoms are periodically superposed to form a multilayer (A→B→A→B→A→B→ . . . ).

In other words, the (0001) plane-orientated hcp structure can be said as a (111) plane-orientated fcc structure from which C layers have been removed. Therefore, the misfit-layered lattice having a fcc structure combined with a bcc structure or with a hcp structure is regarded as positioned between the (111) plane-orientated fcc structure and the (0001) plane-orientated hcp structure.

In the (111) plane-orientated fcc structure, axis symmetry exists in the directions <-111>, <1-11> and <11-1>, in addition to the direction <111> which is normal to the substrate surface. Among the four axis symmetries, the three axis symmetries other than that in <111> disappear due to the laminate defects caused by the incorporation of elements of a bcc structure or a hcp structure. Thus, intermediate layers comprised of an alloy which has a (111) plane-orientated structure and comprising a misfit-layered lattice having a fcc structure combined with a bcc structure, or a (111) plane-orientated structure and comprising a misfit-layered lattice having a fcc structure combined with a hcp structure, have a single <111> axis symmetry.

In the case when a perpendicular magnetic recoding layer is superposed on the non-magnetic underlayer having the above-mentioned symmetry, crystal grains grow with the axis symmetry only in the direction normal to the substrate surface, which is similar to the case a perpendicular magnetic recoding layer is superposed on the non-magnetic underlayer having a hcp structure. Thus the crystal grains in the perpendicular magnetic recording layer are (0001) plane-orientated with a high efficiency.

As specific examples of the material for the above-mentioned non-magnetic underlayer, there can be mentioned (111) plane-orientated alloys such as Pt—Cr, Au—Cr, Pd—Cr, Ir—Cr, Pd—W, Pd—W—Cr and Ir—Ti.

The non-magnetic underlayer comprised of the above-mentioned materials may have a multilayer structure composed of two or more layers.

FIG. 4 is a schematic cross-section of still another example of the perpendicular magnetic recording medium according to the present invention.

As illustrated in FIG. 4, the magnetic recording medium 40 has a multilayer structure which comprises a substrate 1, a soft magnetic underlayer 2 formed on the substrate 1, a non-magnetic underlayer 5 formed on the soft magnetic underlayer 2, a perpendicular magnetic recording layer 3 formed on the non-magnetic underlayer 5, and a protective layer 4 formed on the perpendicular magnetic recording layer 3. The perpendicular magnetic recording layer 3 is comprised of three layers, i.e., an auxiliary layer 3-1, a non-magnetic intermediate layer 3-2 and a primary recording layer 3-3.

The provision of the seed layer 6 between the soft magnetic underlayer 2 and the non-magnetic underlayer 5 is preferable because the crystal orientation in the non-magnetic underlayer is enhanced.

The seed layer is preferably comprised of metal or an alloy, which is selected from Pd, Pt, Ta, Ni—Ta, Ni—Nb, Ni—Zr, Ni—Fe—Cr and Ni—Fe.

As the soft magnetic under layer comprised of a soft magnetic material, a layer comprised of a material having a negative Ku value can be used.

For example, in the case when the auxiliary layer is comprised of (0001) plane-orientated CoIr—SiO₂ having a hcp structure and the primary recording layer is comprised of (0001) plane-orientated CoPtCr—SiO₂ having a hcp structure, a layer comprised of (0001) plane-orientated Co—Ir having a hcp structure can be used. The (0001) plane-orientated Co—Ir having a hcp structure have crystalline structure and lattice constant which are similar to those of the non-magnetic underlayer, and therefore, the layer comprised of this material have a function of the soft magnetic underlayer and a function of the above-mentioned non-magnetic underlayer.

The non-magnetic substrate includes, for example, a glass substrate, aluminum alloy substrates, a surface-oxidized silicon single crystal substrate, a ceramic substrate and a plastic substrate. These substrates may be plated with a Ni—P alloy or other alloys.

A protective layer can be formed on the perpendicular magnetic recording layer. The material for the protective layer includes, for example, carbon, diamond-like carbon (DLC), SiNₓ, SiOₓ and CNₓ.

The formation of the layers can be conducted by various methods such as vacuum deposition, sputtering, molecular beam epitaxy, ion beam deposition, laser ablation and chemical vapor deposition.

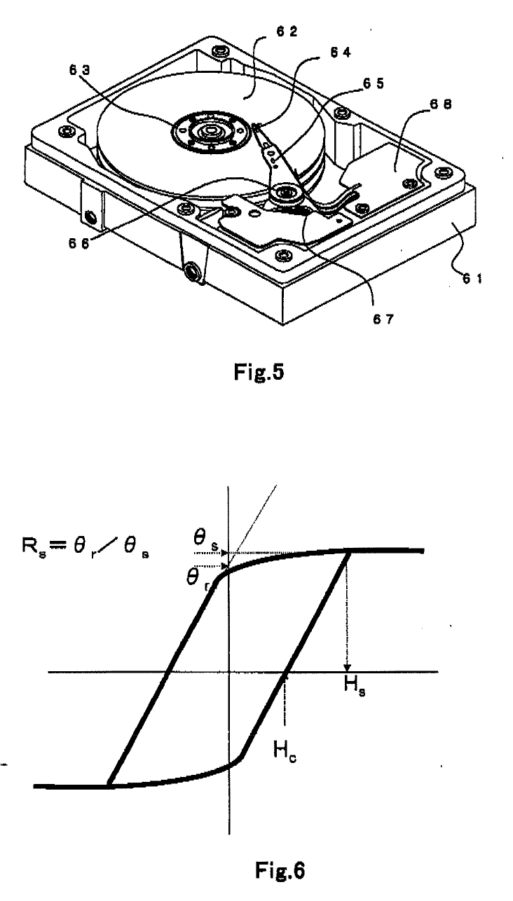

FIG. 5 is a perspective illustration of an example of the magnetic recording reproducing apparatus provided with the perpendicular magnetic recording medium and a magnetic head, according to the present invention.

A magnetic disk 51 for recording information is mounted on a spindle 52, and driven by a spindle motor (not shown) so as to be rotated at a predetermined rotation number. A recording head for recording information from a magnetic disk 51 and a MR head for reproducing the information are mounted on a slider 53. The slider 53 is fitted to a tip of a leaf spring suspension 54. The suspension 54 is connected to an end portion of an arm 55 which is provided with a bobbin part holding a drive coil (not shown).

A voice coil motor 56, i.e., a kind of linear motor, is mounted on the other end portion of the arm 55. The voice coil motor 56 comprises the driving coil (not shown) wound in the bobbin part, and a magnetic circuit comprising permanent magnet, fitted at a confronting position so as to sandwiching the drive coil, and a confronting yoke.

The arm 55 is supported by ball bearings (not shown) fitted on the upper part and lower part of a fixed axis 57. The arm 55 is rotatably and oscillatable driven by the voice coil motor 56. Thus the position of the slider 53 above the magnetic disk 51 is controlled by the voice coil motor 56. Reference numeral 58 is a housing.

### EXAMPLES

Now the invention will be described specifically by the following examples.

### Example 1

A non-magnetic glass substrate having a 2.5 inch diameter hard disk shape (MEL3 available from Konica Minolta Glass Tech., Co., Ltd.) was placed in a vacuum chamber of a sputtering equipment (c-3010 type available from Anelva Corporation.

The vacuum chamber was evacuated to a reduced pressure of below 1×10⁻⁵ Pa. Then the following layers were formed thereon in the following order. Subscripts in the respective elements in the composition of each layer refer to the atomic ratios of the respective elements. The same meaning hereinafter applies for subscripts in elements of compositions.

(i) A soft magnetic underlayer having a composition of Co₉₀—Zr₅—Nb₅ and a thickness of 100 nm.

(ii) A non-magnetic underlayer comprised of ruthenium and having a thickness of 20 nm.

(iii) An auxiliary layer having a composition of (Co₈₆—Ir₁₄b)-8 mole % SiO₂ having a thickness of 5 nm.

(iv) A non-magnetic intermediate layer comprised of ruthenium and having a thickness of 1.2 nm.

(v) A primary recording layer having a composition of (Co₇₈—Cr₆—Pt₁₆)-8 mole % SiO₂ having a thickness of 15 nm.

(vi) A protective layer comprised of carbon and having a thickness of 5 nm.

Further, the surface of the protective layer was coated with a perfluoro-polyether (PFPE) lubricant with a thickness of 13 angstroms by dip coating, to give a perpendicular magnetic recording medium.

The formation of the soft magnetic Co₉₀—Zr₅—Nb₅ underlayer (i) and the protective carbon layer (vi) were conducted at a reduced pressure of 0.7 Pa in an argon atmosphere. The formation of the non-magnetic ruthenium underlayer (ii), the primary recording layer (v) comprised of (Co₇₈—Cr₆—Pt₁₆)-8 mole % SiO₂, the non-magnetic ruthenium intermediate layer (iv), and the auxiliary layer (iii) comprised of (Co₈₆—Ir₁₄b)-8 mole % SiO₂ were conducted at a reduced pressure of 4 Pa in an argon atmosphere.

Sputtering for the formation of the above layers (i) through (vi) was conducted by a DC sputtering method using sputtering targets having a diameter of 164 mm and comprised of Co₉₀—Zr₅—Nb₅(i), ruthenium (ii), (Co₈₆—Ir₁₄b)-8 mole % SiO₂ (iii), ruthenium (iv), (Co₇₈—Cr₆—Pt₁₆)-8 mole % SiO₂ (v) and carbon (vi), respectively. In all of the above-mentioned sputtering procedures, the electric power for each target was 500 W, the distance between the substrate and the target was 50 mm, and the sputtering temperature was room temperature.

As modifications, perpendicular magnetic recording mediums were made by the same procedures as mentioned above, except that a non-magnetic intermediate layer comprised of rhodium or iridium was formed instead of the non-magnetic ruthenium layer. All other procedures and conditions remained the same.

### Comparative Example 1

For comparison, a conventional perpendicular magnetic recording medium was made by the same procedures as mentioned in Example 1, wherein the thickness of the primary recording layer was changed to 20 nm, and the auxiliary layer and the non-magnetic intermediate layer were not formed with all other procedures and conditions remaining the same.

### Comparative Example 2

A perpendicular magnetic recording medium was made by the same procedures as mentioned in Example 1, wherein the non-magnetic intermediate layer were not formed with all other procedures and conditions remaining the same.

### Comparative Example 3

A perpendicular magnetic recording medium was made by the same procedures as mentioned in Example 1, wherein the non-magnetic intermediate layer with a thickness of 1.2 nm was formed from palladium instead of ruthenium with all other procedures and conditions remaining the same.

The micro-structure of each perpendicular magnetic recording medium was evaluated using a TEM at an accelerating voltage of 400 kV.

The relationship between magnetic field strength (H) and magnetic flux density (B) was plotted to give a hysteresis loop as measured in the direction perpendicular to the perpendicular magnetic recording layer of each perpendicular magnetic recording medium. This measurement was carried out by a polar Kerr effect measuring equipment (“BH-M800UV-HD-10” available from Neoark Corporation) using a laser source with a wavelength of 408 nm. The applied maximum imposed magnetic field was 20 kOe. The adopted sweap-rate of fields was 133 Oe/s.

FIG. 6 is an example of hysteresis loop obtained when a squareness ratio Rs is below 1. Coercive force Hc, squareness ratio Rs and saturation magnetic field Hs are schematically shown in FIG. 6.

Crystalline structure and planer orientation of crystals were evaluated by the θ-2θ method using X-ray diffraction apparatus “X 'pert-MRD” available from Phillips Co. wherein Cu-Kα ray is generated at an accelerating voltage of 45 kV and a filament current of 40 mA.

R/W characteristic of each perpendicular magnetic recording medium was evaluated using a spin stand. As a magnetic head, a combination of a single pole head with a recording track width of 0.3 μm and an MR head with a reproducing track width of 0.2 μm. The measurement was carried out at a constant position of radius 20 mm and a disk rotation of 4200 rpm.

As SNR of the medium, signal-to-noise ratio (SNRm) was determined on a differential wave curve obtained by passing through a differential circuit. For the determination of signal-to-noise ratio, an output of signal at a linear recording density of 119 kfci is measured and the measured value is denoted as S. An output of noise at a linear recording density of 716 kfci is measured and the measured value is expressed as rms (root mean square) which is denoted as Nm. The ratio S/Nm denotes the signal-to-noise ratio which is expressed as SNRm in this specification.

O/W characteristic of each perpendicular magnetic recording medium was evaluated by measurement of attenuation rate of reproduction output of a signal of 119 kfci, which was conducted after recording of signal of 119 kfci, and then, before and after overwriting a signal of 250 kfci.

Heat fluctuation characteristic of each perpendicular magnetic recording medium was evaluated by measuring a reproduction output (V₀) of a signal of 100 kfci immediately after the recording of a signal of 100 kfci, and a reproduction output (V₁₀₀₀) of a signal of 100 kfci after leaving to stand for 1000 seconds. The heat fluctuation characteristic was expressed by the ratio V₀/V₁₀₀₀.

Saturation magnetization Ms of the auxiliary layer was evaluated by a vibrating sample magnetometer (VSM) “BHV-55” available from Riken Denshi Co., Ltd.

Ku value of the auxiliary layer was evaluated by a torque magnetometer “TRT-2-15” available from Toei Industrial Co., Ltd. The Ku value was calculated from amplitude of a torque curve obtained at an applied magnetic field of 21 Oe.

When a soft magnetic underlayer with a thickness of 100 nm is provided, a large saturation magnetization of the soft magnetic underlayer can be an obstacle to the measurement of a Ku value of the auxiliary by a torque magnetometer and a saturation magnetization Ms of the auxiliary layer by a VSM. Therefore, a magnetic recording medium for test of magnetic characteristic was prepared by replacing a Co₉₀Zr₅Nb₅ soft magnetic underlayer with a thickness of 100 nm by a Ni—Ta non-magnetic non-crystalline underlayer with a thickness of 100 nm. A hysteresis loop of the magnetic recording medium for test as measured by a polar Kerr effect measuring equipment was substantially the same as the hysteresis loop of the magnetic recording medium having an unsubstituted soft magnetic Co₉₀Zr₅Nb₅ underlayer with a thickness of 100 nm. Therefore, magnetic characteristics of the auxiliary layer and the primary recording layer of the former medium are regarded approximately the same as those of the latter medium.

Thus, the Ku value and Ms of the auxiliary layer of the magnetic recording medium for test having a Ni—Ta non-magnetic non-crystalline underlayer are regarded approximately the same as those of the auxiliary layer of the magnetic recording medium for test having a Co₉₀Zr₅Nb₅ soft magnetic underlayer as prepared in Example 1. Hence, in the following working examples, Ku value and Ms of each auxiliary layer were evaluated by measuring Ku value and Ms of a laminate structure for test having a Ni—Ta non-magnetic underlayer instead of a soft magnetic underlayer, and from which structure the non-magnetic intermediate layer and the primary recording layer have been removed.

Results of XRD Evaluation

XRD analysis reveled that magnetic crystal grains in the primary recording layer in each of the perpendicular magnetic recording mediums prepared in all of the working examples had a hcp structure and were (0001) plane-orientated. It was revealed that magnetic crystal grains in the auxiliary layer in each of the perpendicular magnetic recording mediums prepared in Example 1 and Comparative Examples 2 and 3 had a hcp structure and were (0001) plane-orientated, and further revealed that ruthenium in the non-magnetic underlayers in all of the mediums had a hcp structure and was (0001) plane-orientated.

Results of Plane TEM Observation

Plane TEM observation showed that the primary recording layers of all of the perpendicular magnetic recording mediums had a granular structure comprised of magnetic crystal grains and grain boundary portions surrounding the crystal grains. The magnetic crystal grains had an average particle diameter of 7.8 nm. Composition analysis by TEM-EDX revealed that magnetic crystal grains in the primary recording layers of all of the perpendicular magnetic recording mediums contained Co, Pt and Cr.

The auxiliary layers in the perpendicular magnetic mediums prepared in Example 1 and Comparative Examples 2 and 3 had a granular structure comprised of magnetic crystal grains and grain boundary portions surrounding the crystal grains, which is similar to that in the primary recording layers. The magnetic crystal grains had an average particle diameter of 7.5 nm. Composition analysis by TEM-EDX revealed that magnetic crystal grains in the auxiliary layers of the perpendicular magnetic recording mediums prepared in Example 1 and Comparative Examples 2 and 3 contained Co and Ir.

Results of Ku evaluation by Torque Magnetometer

The Ku value of the auxiliary layers in the perpendicular magnetic mediums prepared in Example 1 and Comparative Examples 2 and 3 was negative, more specifically, −1.3×10⁶ erg/cc.

Hc, Rs and Hs obtained from hysteresis curves of the perpendicular magnetic recording mediums are shown in FIG. 1. As seen from these data, Hc and Hs of the mediums prepared in Example 1 and Comparative Examples 2 and 3 are smaller than those of the medium prepared in Comparative Example 1. The squareness ratio of the mediums prepared in Example 1 and Comparative Example 1 was 1, but, the squareness ratio of the mediums prepared in Comparative Examples 2 and 3 was reduced to below 1.

SNRm, OW and V₁₀₀₀/V₀ of the perpendicular magnetic recording mediums are shown in Table 2. As seen from Table 2, the mediums prepared in Example 1 and Comparative Examples 2 and 3 exhibited enhanced OW characteristic. This benefit is believed to be due to the reduced Hc and Hs. The mediums prepared in Example 1 and Comparative Example 1 exhibited approximately the same resistances to heat fluctuation, but, the mediums prepared in Comparative Examples 2 and 3 exhibited undesirably reduced resistances to heat fluctuation as compared with those in Example 1 and Comparative Example 1. These reduced heat fluctuation resistances are believed to be due the reduced squareness ratios.

TABLE 1

| | Hc [kOe] | Hs [kOe] | Rs |
|---|---|---|---|
| Example 1 | 5.0 | 9.5 | 1 |
| Non-magnetic intermediate layer: Ru | | | |
| Example 1 | 5.2 | 9.7 | 1 |
| Non-magnetic intermediate layer: Ir | | | |
| Example 1 | 5.1 | 9.5 | 1 |
| Non-magnetic intermediate layer: Rh | | | |
| Comparative Example 1 | 6.8 | 12.7 | 1 |
| Comparative Example 2 | 4.3 | 9.0 | 0.9 |
| Comparative Example 3 | 3.5 | 8.8 | 0.7 |

TABLE 2

| | SNRm | OW | |
|---|---|---|---|
| | [dB] | [dB] | V₁₀₀₀/V₀ |
| Example 1 | 14.1 | 34.4 | 0.999 |
| Non-magnetic intermediate layer: Ru | | | |
| Example 1 | 13.9 | 33.1 | 0.999 |
| Non-magnetic intermediate layer: Ir | | | |
| Example 1 | 14.0 | 33.8 | 0.999 |
| Non-magnetic intermediate layer: Rh | | | |
| Comparative Example 1 | 11.7 | 18.2 | 0.999 |
| Comparative Example 2 | 13.3 | 35.3 | 0.951 |
| Comparative Example 3 | 12.7 | 28.1 | 0.902 |

### Example 2

Perpendicular magnetic recording mediums having an auxiliary layer comprised of Co—Ir were prepared as follows, wherein the content of Ir in each auxiliary layer was varied in the range of from 0% to 45% by atom.

By the same procedures as described in Example 1, a soft magnetic underlayer and a non-magnetic underlayer were formed in turn on the substrate to give a laminate. An auxiliary layer comprised of (Co₁₀₀₋ₓ—Irₓ)-8 mole % SiO₂ was formed into a thickness of 5 nm on the laminate. Further, a non-magnetic intermediate layer, a primary recording layer and a protective layer were formed thereon in turn, and further a lubricant was coated thereon.

The percent (x) of Ir in each (Co₁₀₀₋ₓ—Irₓ)-8 mole % SiO₂ auxiliary layer was varied from each other in the range of from 0% to 45% by atom. The formation of each auxiliary layer was conducted under a reduced pressure of 4 Pa by a three-targets simultaneous sputtering method using three targets comprised of Co, Ir and SiO₂, respectively, and having a diameter of 90 mm, at different input powers for the three targets for varying the content of Ir in each layer.

Results of XRD Evaluation

XRD analysis reveled that magnetic crystal grains in the primary recording layer in each of the perpendicular magnetic recording mediums prepared in this example had a hcp structure and were (0001) plane-orientated. It was also revealed that magnetic crystal grains in the auxiliary layer in each of the perpendicular magnetic recording mediums had a hcp structure and were (0001) plane-orientated, and further revealed that ruthenium in the non-magnetic underlayers in all of the mediums had a hcp structure and was (0001) plane-orientated.

Results of Plane TEM Observation

Plane TEM observation showed that the primary recording layers of all of the perpendicular magnetic recording mediums had a granular structure comprised of magnetic crystal grains and grain boundary portions surrounding the crystal grains. Composition analysis by TEM-EDX revealed that magnetic crystal grains in the primary recording layers of all of the perpendicular magnetic recording mediums contained Co, Pt and Cr.

Plane TEM observation showed that the auxiliary layers of all of the perpendicular magnetic recording mediums had a granular structure comprised of magnetic crystal grains and grain boundary portions surrounding the crystal grains, which was similar to the primary recording layers. Composition analysis by TEM-EDX revealed that magnetic crystal grains in the auxiliary layers of all of the mediums contained Co and Ir.

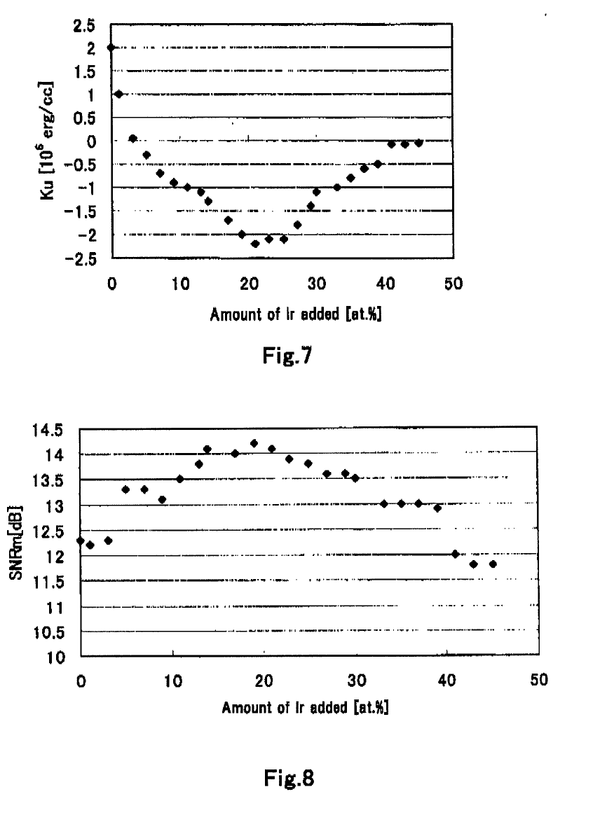

FIG. 7 shows the relationship between an amount (% by atom) of iridium added in the auxiliary layer and a crystalline isotropy energy (Kᵤ) of the auxiliary layer as evaluated by a torque magnetometer. The data in FIG. 7 show that, when the content of Ir is at least 5% by atom, the Ku was negative and its absolute value was at least 10⁵ erg/cc.

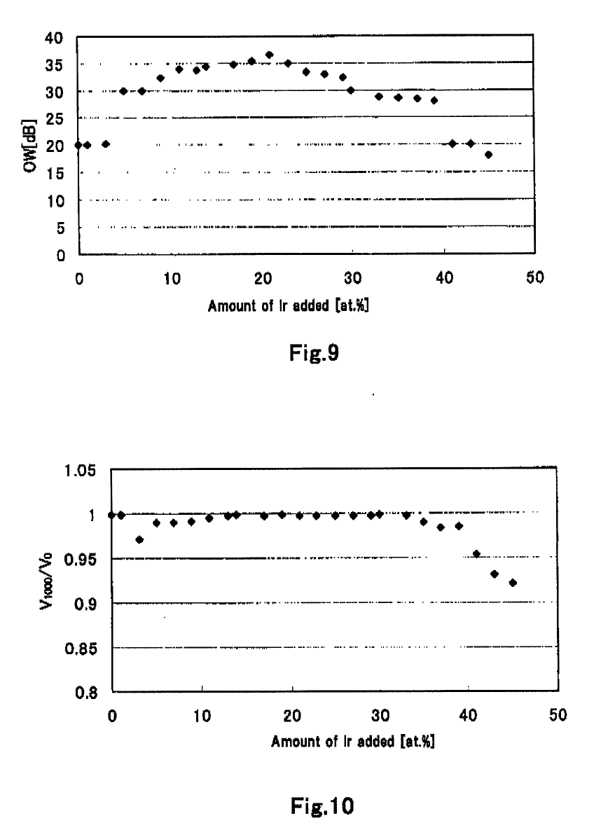

FIGS. 8, 9 and 10 show the relationships between an amount of iridium added in the auxiliary layer and SNRm, OW (overwrite) characteristic and V₁₀₀/V₀ ratio of the magnetic recording mediums, respectively. The data in these figures show that, when the content of Ir is in the range of 5% to 40% by atom, the OW characteristic and the other characteristic are enhanced to the desired extent.

### Example 3

Perpendicular magnetic recording mediums were prepared as follows, wherein the composition of grain boundary portions in each primary recording layer and each auxiliary layer was varied.

By the same procedures as described in Example 1, a soft magnetic underlayer and a non-magnetic underlayer were formed in turn on the substrate to give a laminate. An auxiliary layer comprised of (Co₈₆—Ir₁₄)-y mole % SiO₂ was formed into a thickness of 5 nm on the laminate. Further, a non-magnetic intermediate layer was formed by the same procedures as in Example 1, and then a primary recording layer comprised of (Co₇₈—Cr₆—Pt₁₆)-z mole % SiO₂ was formed thereon, and then, a protective layer and a lubricant coating were formed, by the same procedures as in Example 1.

The formation of each [(CO₈₆—Ir₁₄)-y mole % SiO₂] auxiliary layer was conducted under a reduced pressure of 4 Pa by a two-targets simultaneous sputtering method using two targets comprised of (Co₈₆—Ir₁₄), and SiO₂, respectively, and having a diameter of 90 mm, at different input powers for the two targets for varying the content of SiO₂ in each layer.

The formation of each [(Co₇₈—Cr₆—Pt₁₆)-z mole % SiO₂] primary recording layer was conducted under a reduced pressure of 4 Pa by a two-targets simultaneous sputtering method using two targets comprised of (Co₇₈—Cr₆—Pt₁₆), and SiO₂, respectively, and having a diameter of 90 mm, at different input powers for the two targets for varying the content of SiO₂ in each layer.

For comparison, perpendicular magnetic recording mediums were prepared by the same procedures as mentioned above, wherein the grain boundary portions in the primary recording layer and the auxiliary layer in each medium were comprised of TiO, TiO₂ or Cr₂O₃, instead of SiO₂, with all other conditions remaining the same.

Results of XRD Evaluation

XRD analysis reveled that magnetic crystal grains in the primary recording layer in each of the perpendicular magnetic recording mediums prepared in this example had a hcp structure and were (0001) plane-orientated. It was also revealed that magnetic crystal grains in the auxiliary layer in each of the perpendicular magnetic recording mediums had a hcp structure and were (0001) plane-orientated, and further revealed that ruthenium in the non-magnetic underlayers in all of the mediums had a hcp structure and was (0001) plane-orientated.

Results of Plane TEM Observation

Plane TEM observation showed that the primary recording layers of the perpendicular magnetic recording mediums wherein the proportion (z) of SiO₂ is at least 5% by mole had a granular structure comprised of magnetic crystal grains and grain boundary portions surrounding the crystal grains. Composition analysis by TEM-EDX revealed that magnetic crystal grains in the primary recording layers of all of the perpendicular magnetic recording mediums contained Co, Pt and Cr.

Plane TEM observation showed that the auxiliary layers of the perpendicular magnetic recording mediums wherein the proportion (y) of SiO₂ is at least 5% by mole had a granular structure comprised of magnetic crystal grains and grain boundary portions surrounding the crystal grains. Composition analysis by TEM-EDX revealed that magnetic crystal grains in the auxiliary layers of all of the mediums contained Co and Ir.

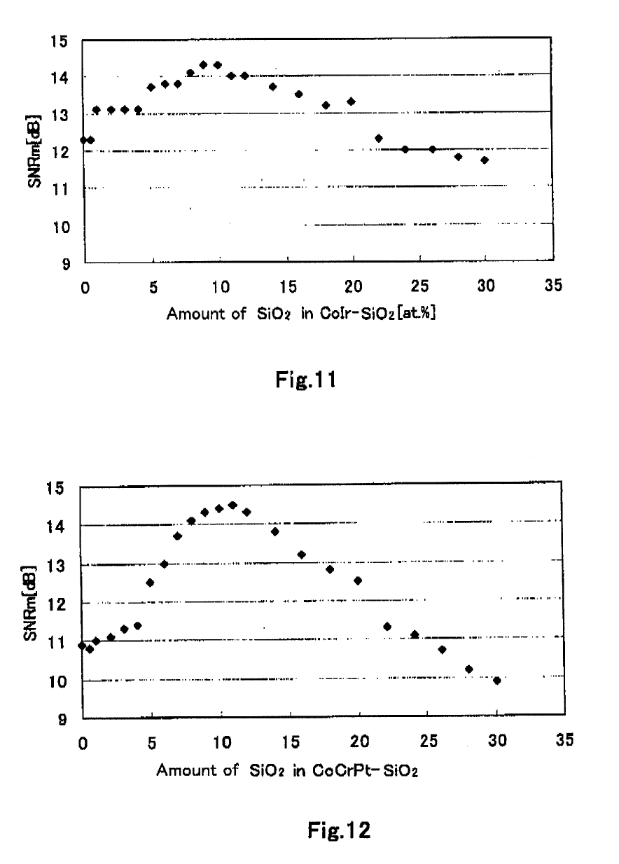

FIG. 11 shows the relationship between an amount (y % by mole) of SiO₂ in the auxiliary layer and SNRm of the magnetic recording mediums, wherein the proportion (z % by mole) of SiO₂ in the primary recording layer was maintained at a constant value of 8 and the proportion (y % by mole) of SiO₂ in the auxiliary layer was varied in the range of from 0 to 30% by mole.

The data in FIG. 11 show that, when the content of SiO₂ is in the range of from 1% to 20% by mole, the SNRm is enhanced to the desired extent. Similar benefits were obtained in the mediums wherein the grain boundary portions in the primary recording layer and the auxiliary layer in each medium were comprised of TiO, TiO₂, or Cr₂O₃, instead of SiO₂.

FIG. 12 shows the relationship between an amount (z % by mole) of SiO₂ in the primary recording layer and SNRm of the magnetic recording mediums, wherein the proportion (y % by mole) of SiO₂ in the auxiliary layer was maintained at a constant value of 8 and the proportion (z % by mole) of SiO₂ in the primary recording layer was varied in the range of from 0 to 30% by mole.

The data in FIG. 12 show that, when the content of SiO₂ is in the range of from 5% to 20% by mole, the SNRm is enhanced to the desired extent. Similar benefits were obtained in the mediums wherein the grain boundary portions in the primary recording layer and the auxiliary layer in each medium were comprised of TiO, TiO₂, or Cr₂O₃, instead of SiO₂.

### Example 4

Perpendicular magnetic recording mediums were prepared as follows, wherein the non-magnetic intermediate layer were comprised of Ru—SiO₂ instead of Ru.

By the same procedures as described in Example 1, a soft magnetic underlayer, a non-magnetic underlayer and an auxiliary layer were formed in turn on the substrate to give a laminate. A non-magnetic intermediate layer comprised of Ru-a mole % SiO₂ was formed into a thickness of 1.2 nm on the laminate. Further, a primary recording layer, a protective layer and a lubricant coating were formed in this turn, by the same procedures as in Example 1.

The formation of each [Ru-a mole % SiO₂] non-magnetic intermediate layer was conducted under a reduced pressure of 4 Pa by a two-targets simultaneous sputtering method using two targets comprised of Ru and SiO₂, respectively, and having a diameter of 90 mm, at different input powers for the two targets for varying the content of SiO₂ in each layer.

For comparison, perpendicular magnetic recording mediums were prepared by the same procedures as mentioned above, wherein the grain boundary portions in the nonmagnetic intermediate layer in each medium were comprised of TiO, TiO₂ or Cr₂O₃, instead of SiO₂, with all other conditions remaining the same.

Results of XRD Evaluation

XRD analysis reveled that magnetic crystal grains in the primary recording layer in each of the perpendicular magnetic recording mediums prepared in this example had a hcp structure and were (0001) plane-orientated. It was also revealed that magnetic crystal grains in the auxiliary layer in each of the perpendicular magnetic recording mediums had a hcp structure and were (0001) plane-orientated, and further revealed that ruthenium in the non-magnetic underlayers in all of the mediums had a hcp structure and was (0001) plane-orientated.

Results of Plane TEM Observation

Plane TEM observation showed that the primary recording layers of all of the perpendicular magnetic recording mediums had a granular structure comprised of magnetic crystal grains and grain boundary portions surrounding the crystal grains. Composition analysis by TEM-EDX revealed that magnetic crystal grains in the primary recording layers of all of the perpendicular magnetic recording mediums contained Co, Pt and Cr.

Plane TEM observation showed that the auxiliary layers of all of the perpendicular magnetic recording mediums had a granular structure comprised of magnetic crystal grains and grain boundary portions surrounding the crystal grains, similarly to the primary recording layers. Composition analysis by TEM-EDX revealed that magnetic crystal grains in the auxiliary layers of all of the mediums contained Co and Ir.

The non-magnetic intermediate layers wherein the proportion (a) of SiO₂ is at least 5% by mole had a granular structure comprised of magnetic crystal grains and grain boundary portions surrounding the crystal grains.

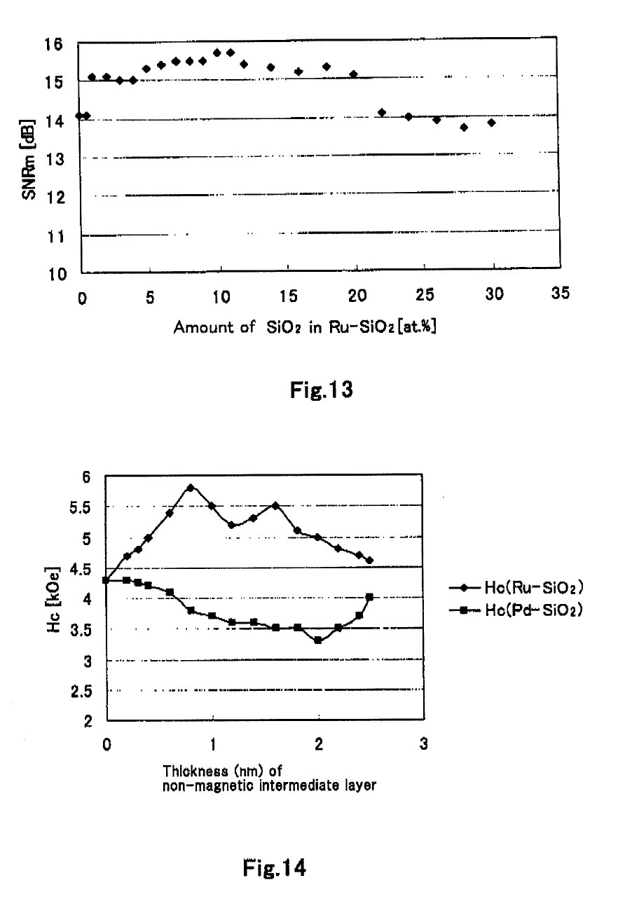

FIG. 13 shows the relationship between an amount (a % by mole) of SiO₂ in the non-magnetic intermediate layer and SNRm of the magnetic recording mediums, wherein the proportion (a % by mole) of SiO₂ in the non-magnetic intermediate layer was varied.

The data in FIG. 13 show that, when the content of SiO₂ is in the range of from 1% to 20% by mole, the SNRm is enhanced to the desired extent. Similar benefits were obtained in the mediums wherein the grain boundary portions in the non-magnetic intermediate layer in each medium were comprised of TiO, TiO₂, or Cr₂O₃, instead of SiO₂.

### Example 5

Perpendicular magnetic recording mediums were prepared as follows, wherein the thickness of the non-magnetic intermediate layer in each medium were varied.

By the same procedures as described in Example 1, a soft magnetic underlayer, a non-magnetic underlayer and an auxiliary layer were formed in turn on the substrate to give a laminate. A non-magnetic intermediate layer comprised of Ru-7 mole % SiO₂ was formed into a thickness varied in the range of from 0 nm to 2.5 nm on the laminate. Further, a primary recording layer, a protective layer and a lubricant coating were formed in this turn, by the same procedures as in Example 1.

The formation of each [Ru-7 mole % SiO₂] non-magnetic intermediate layer was conducted under a reduced pressure of 4 Pa by a DC sputtering method using a target having a composition [Ru-7 mole % SiO₂] and having a diameter of 164 mm.

For comparison, perpendicular magnetic recording mediums were prepared by the same procedures as mentioned above, wherein the composition of the non-magnetic intermediate layer in each medium was varied to [Rh-7 mole % SiO₂] or [Ir-7 mole % SiO₂] instead of [Ru-7 mole % SiO₂], with all other conditions remaining the same.

### Comparative Example 4

A perpendicular magnetic recording medium was prepared by the same procedures as mentioned in Example 5 wherein the composition [Ru-7 mole % SiO₂] of the non-magnetic intermediate layer was varied to [Pd-7 mole % SiO₂] with all other conditions remaining the same.

Results of XRD Evaluation

XRD analysis reveled that magnetic crystal grains in the primary recording layer in each of the perpendicular magnetic recording mediums prepared in Example 5 and Comparative Example 4 had a hcp structure and were (0001) plane-orientated. It was also revealed that magnetic crystal grains in the auxiliary layer in each of the perpendicular magnetic recording mediums had a hcp structure and were (0001) plane-orientated, and further revealed that ruthenium in the non-magnetic underlayers in all of the mediums had a hcp structure and was (0001) plane-orientated.

Results of Plane TEM Observation

Plane TEM observation showed that the primary recording layers of all of the perpendicular magnetic recording mediums had a granular structure comprised of magnetic crystal grains and grain boundary portions surrounding the crystal grains. Composition analysis by TEM-EDX revealed that magnetic crystal grains in the primary recording layers of all of the perpendicular magnetic recording mediums contained Co, Pt and Cr.

Plane TEM observation showed that the auxiliary layers of all of the perpendicular magnetic recording mediums had a granular structure comprised of magnetic crystal grains and grain boundary portions surrounding the crystal grains, similarly to the primary recording layers. Composition analysis by TEM-EDX revealed that magnetic crystal grains in the auxiliary layers of all of the mediums contained Co and Ir.

All of the non-magnetic intermediate layers were also to have a granular structure comprised of magnetic crystal grains and grain boundary portions surrounding the crystal grains.

FIGS. 14 to 18 show the relationship between the thickness of the intermediate layer and Hc, Hs, Rs, SNRm, OW and V₁₀₀₀/V₀, respectively, of the magnetic recording mediums, wherein the composition of the non-magnetic intermediate layer was [Ru-7 mole % SiO₂] or [Pd-7 mole % SiO₂].

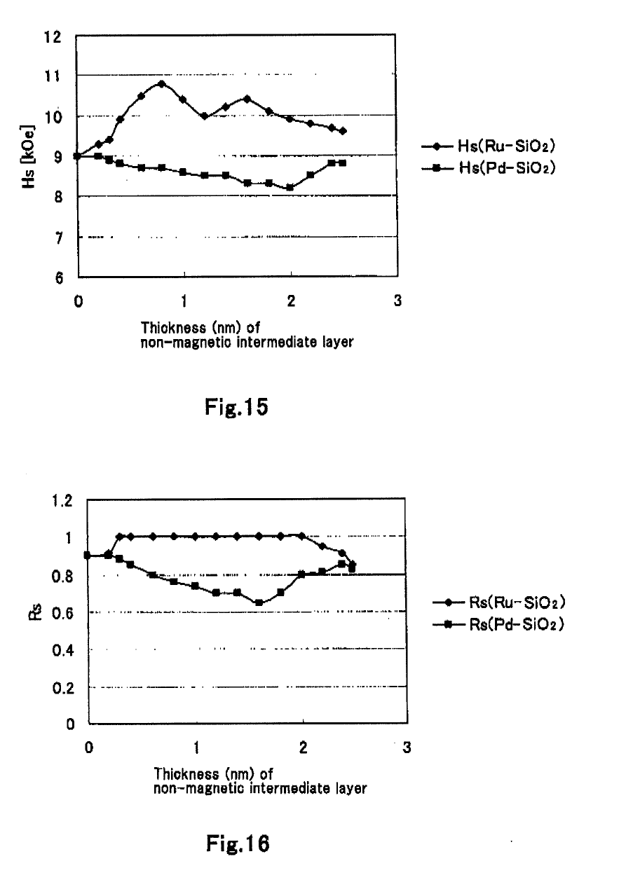

As seen from FIGS. 14 and 15, in the case when the composition of the non-magnetic intermediate layer was Ru—SiO₂, Hc and Hs varied uniquely with an increase of the thickness of the layer. Similar tendency was observed in the case when the composition of the non-magnetic intermediate layer was Rh—SiO₂ or Ir—SiO₂, but, such tendency was not observed in the case when the composition of the non-magnetic intermediate layer was Pd—SiO₂.

As seen from FIG. 16, in the case when the composition of the non-magnetic intermediate layer was Ru—SiO₂, Rs was enhanced to approximately 1 over a thickness range of from 0.3 nm to 2 nm. Similar Rs enhancement was also observed in the case when the composition of the non-magnetic intermediate layer was Rh—SiO₂ or Ir—SiO₂, but, such Rs enhancement was not observed in the case when the composition of the non-magnetic intermediate layer was Pd—SiO₂.

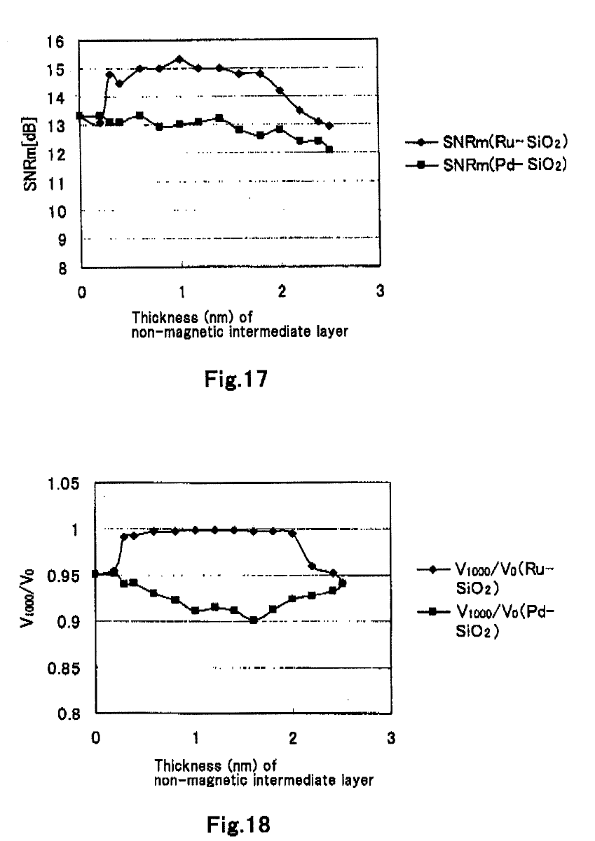

As seen from FIG. 17, in the case when the composition of the non-magnetic intermediate layer was Ru—SiO₂, SNRm was enhanced to the desired extent over a thickness range of from 0.3 nm to 2 nm. Similar SNRm enhancement was also observed in the case when the composition of the non-magnetic intermediate layer was Rh—SiO₂ or Ir—SiO₂, but, such SNRm enhancement was not observed in the case when the composition of the non-magnetic intermediate layer was Pd—SiO₂.

As seen from FIG. 18, in the case when the composition of the non-magnetic intermediate layer was Ru—SiO₂, the V₁₀₀₀/V₀ was enhanced to the desired extent over a thickness range of from 0.3 nm to 2 nm. Similar V₁₀₀₀/V₀ enhancement was also observed in the case when the composition of the non-magnetic intermediate layer was Rh—SiO₂ or Ir—SiO₂, but, the V₁₀₀₀/V₀ was poor in the case when the composition of the non-magnetic intermediate layer was Pd—SiO₂. Such poor V₁₀₀₀/V₀ is believed to be due to the low Rs value.

### Example 6

Perpendicular magnetic recording mediums were prepared as follows, wherein the non-magnetic intermediate layer had a double layer structure comprising Ru—Cr/Ru, Pd—W/Ru, Pt—Cr/Ru, IrCr/Ru or IrTi/Ru, instead of a single layer structure comprising Ru.

By the same procedures as described in Example 1, a soft magnetic underlayer was formed on the substrate to give a laminate. A non-magnetic underlayer (1) comprised of (Pd₆₀-W₄₀) was formed into a thickness of 10 nm and then a non-magnetic underlayer (2) comprised of Ru was formed into a thickness of 10 nm, on the laminate. Further, a primary recording layer, a non-magnetic intermediate layer, an auxiliary layer, a protective layer and a lubricant coating were formed in turn, by the same procedures and under the same conditions as mentioned in Example 1.

The formation of the non-magnetic underlayer (1) was conducted under a reduced pressure of 0.5 Pa by a DC sputtering method using a target having a composition (Pd₆₀—W₄₀) and having a diameter of 164 mm. The formation of the non-magnetic underlayer (2) was conducted under a reduced pressure of 4 Pa by a DC sputtering method using a Ru target having a diameter of 164 mm.

For comparison, perpendicular magnetic recording mediums were prepared by the same procedures as mentioned, wherein the non-magnetic underlayer (1) was comprised of Pt₆₀—Cr₄₀, Ir₄₀—Cr₆₀, Ir₈₀—Ti₂₀ or Ru₆₀—Cr₄₀, instead of Pd₆₀—W₄₀, with all other conditions remaining the same.

Results of XRD Evaluation

XRD analysis reveled that magnetic crystal grains in the primary recording layer in each of the perpendicular magnetic recording mediums prepared in this example had a hcp structure and were (0001) plane-orientated. It was also revealed that magnetic crystal grains in the auxiliary layer in each of the perpendicular magnetic recording mediums had a hcp structure and were (0001) plane-orientated. It was further revealed that ruthenium in the non-magnetic underlayer (2) and Ru₆₀—Cr₄₀ in the non-magnetic underlayer (1) in the mediums had a hcp structure and were (0001) plane-orientated.

Results of XRD and In-Plane XRD Evaluations and TEM Observation

Pd₆₀—W₄₀, Pt₆₀—Cr₄₀, Ir₄₀—Cr₆₀ or Ir₈₀—Ti₂₀ in the non-magnetic underlayer (1) in each of the mediums was (111) plane-orientated and contained a misfit-layered lattice.

Results of Plane TEM Observation

Plane TEM observation showed that the primary recording layers of all of the perpendicular magnetic recording mediums had a granular structure comprised of magnetic crystal grains and grain boundary portions surrounding the crystal grains. Composition analysis by TEM-EDX revealed that magnetic crystal grains in the primary recording layers of all of the perpendicular magnetic recording mediums contained Co, Pt and Cr.

Plane TEM observation showed that the auxiliary layers of all of the perpendicular magnetic recording mediums had a granular structure comprised of magnetic crystal grains and grain boundary portions surrounding the crystal grains. Composition analysis by TEM-EDX revealed that magnetic crystal grains in the auxiliary layers of all of the perpendicular magnetic recording mediums contained Co and Ir.

Plane TEM observation showed that the non-magnetic intermediate layers of the perpendicular magnetic recording mediums wherein the proportion (a) of SiO₂ is at least 5% by mole had a granular structure comprised of magnetic crystal grains and grain boundary portions surrounding the crystal grains.

SNRm, OW and V1₀₀₀/V₀ of the perpendicular magnetic recording mediums are shown in Table 3. As seen from Table 3, good SNRm, OW and V1₀₀₀/V₀ were obtained in the case when the non-magnetic underlayer is comprised of (0001) plane-orientated Ru—Cr alloy having a hcp structure, or (111) plane-orientated alloys containing a misfit-layered lattice, instead of ruthenium.

TABLE 3

| Non-magnetic underlayer | SNRm [dB] |
|---|---|
| Ru | 14.1 |
| Ru₆₀Cr₄₀/Ru | 14.2 |
| Pd₆₀W₄₀/Ru | 14.9 |
| Pt₆₀Cr₄₀/Ru | 14.6 |
| Ir₄₀Cr₆₀/Ru | 14.7 |
| Ir₈₀Ti₄₀/Ru | 14.3 |

### Example 7

A perpendicular magnetic recording medium having a soft magnetic underlayer comprised of Co₉₀—Ir₁₀ was prepared as follows.

By the same procedures and under the same conditions as described in Example 1, a soft magnetic underlayer, a non-magnetic underlayer, an auxiliary layer, a non-magnetic intermediate layer, a primary recording layer, a protective layer and a lubricant coating were formed in this order.

The formation of the soft magnetic underlayer comprised of Co₉₀—Ir₁₀ was conducted under a reduced pressure of 0.7 Pa by a DC sputtering method using a target having a composition (Co₉₀—Ir₁₀) and having a diameter of 164 mm. The soft magnetic underlayer had a thickness of 100 nm.

XRD analysis reveled that magnetic crystal grains in the primary recording layer of the perpendicular magnetic recording medium prepared in this example had a hcp structure and were (0001) plane-orientated. It was also revealed that magnetic crystal grains in the auxiliary layer of the perpendicular magnetic recording medium had a hcp structure and were (0001) plane-orientated.

It was further revealed that ruthenium in the non-magnetic underlayer of the medium had a hcp structure and was (0001) plane-orientated; and Co₉₀—Ir₁₀ in the soft magnetic underlayer of the medium had a hcp structure and was (0001) plane-orientated.

Results of Plane TEM Observation

Plane TEM observation showed that the primary recording layer of the perpendicular magnetic recording medium had a granular structure comprised of magnetic crystal grains and grain boundary portions surrounding the crystal grains. Composition analysis by TEM-EDX revealed that magnetic crystal grains in the primary recording layer of the perpendicular magnetic recording medium contained Co, Pt and Cr.

Plane TEM observation showed that the auxiliary layer of the perpendicular magnetic recording medium had a granular structure comprised of magnetic crystal grains and grain boundary portions surrounding the crystal grains, similarly to the primary recording layer. Composition analysis by TEM-EDX revealed that magnetic crystal grains in the auxiliary layer of the perpendicular magnetic recording medium contained Co and Ir.

SNRm, OW and V1₀₀₀/V₀ of the perpendicular magnetic recording medium are shown in Table 4. As seen from Table 4, in the case when a layer comprised of a material having a negative Ku is used as the soft magnetic underlay, good read/write (R/W) characteristics can be obtained, which is similar to the case when a soft magnetic underlayer comprised of a soft-magnetic material is used.

TABLE 4

| | SNRm | OW | |
|---|---|---|---|
| | [dB] | [dB] | V₁₀₀₀/V₀ |
| Example 1 | 14.1 | 34.4 | 0.999 |
| Example 7 | 15.0 | 34.7 | 0.998 |

### Example 8

A perpendicular magnetic recording medium having a soft magnetic underlayer comprised of Co₉₀—Ir₁₀ but not having a non-magnetic underlayer was prepared as follows.

By the same procedures and under the same conditions as described in Example 7, a soft magnetic underlayer, an auxiliary layer, a non-magnetic intermediate layer, a primary recording layer, a protective layer and a lubricant coating were formed in this order.

XRD analysis reveled that magnetic crystal grains in the primary recording layer of the perpendicular magnetic recording medium prepared in this example had a hcp structure and were (0001) plane-orientated. It was also revealed that magnetic crystal grains in the auxiliary layer of the perpendicular magnetic recording medium had a hcp structure and were (0001) plane-orientated.

It was further revealed that Co₉₀—Ir₁₀ in the soft magnetic underlayer of the medium had a hcp structure and was (0001) plane-orientated.

Results of Plane TEM Observation

Plane TEM observation showed that the primary recording layer of the perpendicular magnetic recording medium had a granular structure comprised of magnetic crystal grains and grain boundary portions surrounding the crystal grains. Composition analysis by TEM-EDX revealed that magnetic crystal grains in the primary recording layer of the perpendicular magnetic recording medium contained Co, Pt and Cr.

Plane TEM observation showed that the auxiliary layer of the perpendicular magnetic recording medium had a granular structure comprised of magnetic crystal grains and grain boundary portions surrounding the crystal grains, similarly to the primary recording layer. Composition analysis by TEM-EDX revealed that magnetic crystal grains in the auxiliary layer of the perpendicular magnetic recording medium contained Co and Ir.

SNRm, OW and V1₀₀₀/V₀ of the perpendicular magnetic recording medium are shown in Table 5. As seen from Table 5, in the case when a layer comprised of a material having a negative Ku is used as the soft magnetic underlay, but a non-magnetic underlayer is not used, read/write (R/W) characteristics can be more enhanced.

TABLE 5

| | SNRm | OW | |
|---|---|---|---|
| | [dB] | [dB] | V₁₀₀₀/V₀ |
| Example 7 | 15.0 | 34.7 | 0.998 |
| Example 8 | 15.5 | 41.1 | 0.997 |

### INDUSTRIAL APPLICABILITY

According to the present invention, a perpendicular magnetic recording medium exhibiting high SNR, good overwrite (OW) characteristic and high resistance to heat fluctuation is provided.

In view of these beneficial characteristics, a magnetic recording/reproducing apparatus provided with this perpendicular magnetic recording medium is suitable for video decks, audio instruments and vehicle navigation systems.

1. A magnetic recording medium comprising a substrate, at least one soft magnetic underlayer formed on the substrate, a perpendicular magnetic recording layer formed on the soft magnetic underlayer, and a protective layer formed on the perpendicular magnetic recording layer;
characterized in that:
said perpendicular magnetic recording layer is comprised of a primary recording layer, a non-magnetic intermediate layer and an auxiliary layer;
the primary recording layer comprises magnetic crystal grains and grain boundary portions surrounding the magnetic crystal grains, and has a perpendicular magnetic anisotropy;
the auxiliary layer has a negative magneto crystalline anisotropy; and
the non-magnetic intermediate layer is formed between the primary recording layer and the auxiliary layer and comprises at least one metal selected from the group consisting of ruthenium, rhodium and iridium, or at least one alloy thereof.

2. The magnetic recording medium according to claim 1, wherein the absolute value of the negative magneto crystalline anisotropy of the auxiliary layer is at least 10⁵ erg/cc.

3. The magnetic recording medium according to claim 1, wherein the auxiliary layer has a thickness of at least 0.5 nm.

4. The magnetic recording medium according to claim 1, wherein the thickness of the auxiliary layer is not larger than a half of the thickness of the primary recording layer.

5. The magnetic recording medium according to claim 1, wherein the auxiliary layer comprises at least one alloy selected from the group consisting of Co—Ir, Co—Fe, Mn—Sb, Fe—C and Fe—Pt.

6. The magnetic recording medium according to claim 5, wherein the auxiliary layer is comprised of a Co—Ir alloy and the content of iridium in the alloy is in the range of 5 to 40% by atom based on the alloy.

7. The magnetic recording medium according to claim 1, wherein the auxiliary layer comprises magnetic crystal grains and grain boundary portions surrounding the magnetic crystal grains, wherein the magnetic crystal grains comprise at least one alloy selected from the group consisting of Co—Ir, Co—Fe, Mn—Sb, Fe—C and Fe—Pt.

8. The magnetic recording medium according to claim 7, wherein the grain boundary portions in the auxiliary layer are comprised of an oxide, nitride or carbide of at least one element selected from the group consisting of Si, Ti, Cr, Al, Mg, Ta and Y.

9. The magnetic recording medium according to claim 8, wherein the total content of the oxide, nitride or carbide in the auxiliary layer is in the range of 1% to 20% by mole, based on the sum of the magnetic crystal grains and the grain boundary portions.

10. The magnetic recording medium according to claim 1, wherein the non-magnetic intermediate layer has a thickness in the range of 0.3 nm to 2 nm.

11. The magnetic recording medium according to claim 1, wherein the non-magnetic intermediate layer comprises crystal grains and grain boundary portions surrounding the crystal grains, wherein the crystal grains are comprised of at least one metal selected from the group consisting of ruthenium, rhodium and iridium, or at least one alloy thereof.

12. The magnetic recording medium according to claim 11, wherein the grain boundary portions in the non-magnetic intermediate layer are comprised of an oxide, nitride or carbide of at least one element selected from the group consisting of Si, Ti, Cr, Al, Mg, Ta and Y.

13. The magnetic recording medium according to claim 12, wherein the total content of the oxide, nitride or carbide in the non-magnetic intermediate layer is in the range of 1% to 20% by mole, based on the sum of the crystal grains and the grain boundary portions.

14. The magnetic recording medium according to claim 1, wherein the magnetic crystal grains in the primary magnetic layer comprise cobalt and platinum, and have a hexagonal close-packed (hcp) structure and are (0001) plane-orientated.

15. The magnetic recording medium according to claim 1, wherein the grain boundary portions in the primary recording layer are comprised of an oxide, nitride or carbide of at least one element selected from the group consisting of Si, Ti, Cr, Al, Mg, Ta and Y.

16. The magnetic recording medium according to claim 15, wherein the total content of the oxide, nitride or carbide in the primary recording layer is in the range of 5% to 20% by mole based on the sum of the magnetic crystal grains and the grain boundary portions.

17. The magnetic recording medium according to claim 1, wherein the soft magnetic underlayer comprises metal or an alloy, which is at least one selected from the group consisting of Co—Zr—Nb, Co—B, Co—Ta—Zr, Fe—Si—Al, Fe—Ta—C, Co—Ta—C, Ni—Fe, Fe, Fe—Co—B, Fe—Co—N, Fe—Ta—N and Co—Ir.

18. The magnetic recording medium according to claim 1, wherein the soft magnetic underlayer is comprised of a Co—Ir alloy and the content of iridium in the alloy is in the range of 5% to 40% by atom based on the alloy.

19. The magnetic recording medium according to claim 1, which further comprises a non-magnetic underlayer, comprised of metal or an alloy, and formed between the soft magnetic underlayer and the perpendicular magnetic recording layer; wherein said metal or said alloy in the non-magnetic underlayer has a (0001) plane-orientated hexagonal close-packed (hcp) structure; or a (111) plane-orientated structure comprising a face-centered cubic (fcc) structure combined with a body-centered cubic (bcc) structure, including stacking faults or a (111) plane-orientated structure comprising a face-centered cubic (fcc) structure combined with a hexagonal close-packed (hcp) structure, including stacking faults.

20. The magnetic recording medium according to claim 19, wherein the non-magnetic underlayer is comprised of metal or an alloy, which is at least one selected from those which are (0001) plane-orientated and selected from the group consisting of Ru, Ti, Re, Ru—Cr, Ru—W and Ru—Co, and those which are (111) plane-orientated and selected from the group consisting of Pt—Cr, Au—Cr, Pd—Cr, Ir—Cr, Pd—W, Pd—W—Cr and Ir—Ti.

21. The magnetic recording medium according to claim 19, which further comprises a seed layer formed between the soft magnetic underlayer and the non-magnetic underlayer.

22. The magnetic recording medium according to claim 21, wherein the seed layer is comprised of metal or an alloy, which is at least one selected from the group consisting of Pd, Pt, Ta, Ni—Ta, Ni—Nb, Ni—Zr, Ni—Fe—Cr and Ni—Fe.

23. A magnetic recording reproducing apparatus provided with the magnetic recording medium as claimed in claim 1, and a magnetic head for recording and reproducing an information.
